(19) United States
(12) Patent Application Publication
(10) Pub. No.: US 2004/0136379 A1
(43) Pub. Date: Jul. 15, 2004

(54) Method and apparatus for allocation of resources

(76) Inventors: Raymond R Liao, North York (CA); Andrew T Campbell, New York, NY (US)

Correspondence Address: BAKER & BOTTS, 30 ROCKEFELLER PLAZA, NEW YORK, NY, 10112

(21) Appl. No.: 10/220,777

(22) PCT Filed: Mar. 13, 2001
(86) PCT No.: PCT/US01/08057

(51) Int. Cl. H04L 12/28

(52) U.S. Cl. 370/395.21; 370/254

(57) ABSTRACT

A method and apparatus for allocating limited network resources, such as bandwidth and buffer memory, among various categories of data. Scheduler software adjusts the service weights associated with various data categories in order to regulate packet loss and delay. Central control software monitors network traffic conditions and regulates traffic at selected ingresses in order to reduce congestion at downstream bottlenecks. An advantageous method of calculating data utility functions enables utility maximization and/or fairness of resource allocation. Traffic at selected egresses is regulated in order to avoid wasting underutilized resources due to bottlenecks elsewhere in the network.

### CROSS-REFERENCE TO RELATED APPLICATION

The present application claims priority to United States Provisional Patent Application entitled “Dynamic Provisioning of Network Capacity to Support Quantitatively Differentiated Internet Services,” Serial No. 60/188,899, which was filed on Mar. 23, 2000.

### BACKGROUND OF THE INVENTION

Efficient and accurate capacity provisioning for differentiated services (“DiffServ”) networks—e.g., the Internet—can be significantly more challenging than provisioning for traditional telecommunication services (e.g., telephony circuit, leased lines, Asynchronous Transfer Mode (ATM) virtual paths, etc.). This stems from the lack of detailed network control information regarding, e.g., “per-flow” states (i.e., flows of defined groups of data). Rather than supporting per-flow state and control, DiffServ aims to simplify the resource management problem, thereby gaining architectural scalability through provisioning the network on a per-aggregate basis—i.e., for aggregated sets of data flows. Relaxing the need for fine-grained state management and traffic control in the core network inevitably leads to coarser and more approximate forms of network control, the dynamics of which are still not widely understood. The DiffServ model results in some level of service differentiation between service classes (i.e., prioritized types of data) that is “qualitative” in nature. However, there is a need for sound “quantitative” rules to control network capacity provisioning.

The lack of quantitative provisioning mechanisms has substantially complicated the task of network provisioning for multi-service networks. The current practice is to bundle numerous administrative rules into policy servers. This ad-hoc approach poses two problems. First, the policy rules are mostly static. The dynamic rules (for example, load balancing based on the hour of the day) remain essentially constant on the time scale of network management that is designed for monitoring and maintenance tasks. These rules are not adjusted in response to the dynamics of network traffic on the time scale of network control and provisioning. The consequence is either under-utilization or no quantitative differentiation for the quality-sensitive network services. Second, ad-hoc rules are complicated to define for a large network, requiring foresight on the behavior of network traffic with different service classes. In addition, ensuring the consistency of these rules becomes challenging as the number of network services and the size of a network grows.

A number of researchers have attempted to address this problem. Core stateless fair queuing (CSFQ) maintains per-flow rate information in packet headers leading to fine-grained per-flow packet-dropping that is locally fair (i.e., at a local switch). However, this approach cannot support maximum fairness due to the fact that downstream packet drops lead to wasted bandwidth at upstream nodes. Other schemes that support admission control, such as Jitter-VC and CEDT, deliver quantitative services with stateless cores. However, these schemes achieve this at the cost of implementation complexity and the use of packet header state space. “Hose-type” architectures use traffic traces to investigate the impact of different degrees of traffic aggregation on capacity provisioning. However, no conclusive provisioning rules have been proposed for this type of architecture. The proportional delay differentiation scheme defines a new qualitative relative-differentiation service as opposed to quantifying absolute-differentiated services. However, the service definition relates to a single node and not a path through the core network. Researchers have attempted to calculate a delay bound for traffic aggregated inside a core network. However, the results of such studies indicate that for real-time applications, the only feasible provisioning approach for static service level specifications is to limit the traffic load well below the network capacity.

### SUMMARY OF THE INVENTION

It is therefore an object of the present invention to provide a suite of algorithms capable of delivering automatic capacity provisioning in an efficient and scalable manner providing quantitative service differentiation across service classes. Such algorithms can make most policy rules unnecessary and simplify the provisioning of large multi-service networks, which can translate into significant savings to service providers by removing the engineering challenge of operating a differentiated service network. The procedures of the present invention can enable quantitative service differentiation, improve network utilization, and increase the variety of network services that can be offered to customers.

In accordance with one aspect of the present invention, there is provided a method of allocating network resources, comprising the steps of: measuring at least one network parameter related to at least one of an amount of network resource usage, an amount of network traffic, and a service quality parameter; applying a formula to the at least one network parameter to thereby generate a calculation result, the formula being associated with at least one of a Markovian process and a Poisson process; and using the calculation result to dynamically adjust an allocation of at least one of the network resources.

In accordance with an additional aspect of the present invention, there is provided a method of allocating network resources, comprising the steps of: determining a first amount of data traffic flowing to a first network link, the first amount being associated with a first traffic aggregate; determining a second amount of data traffic flowing to the first network link, the second amount being associated with a second traffic aggregate; and using at least one adjustment rule to adjust at least one of a first aggregate amount and a second aggregate amount, the first aggregate amount comprising the first amount of data traffic and a third amount of data traffic associated with the first traffic aggregate and not flowing through the first network link, the second aggregate amount comprising the second amount of data traffic and a fourth amount of data traffic associated with the second traffic aggregate and not flowing through the first network link, and the at least one adjustment rule being based on at least one of fairness, a branch penalty, and maximization of an aggregated utility.

In accordance with a further aspect of the present invention, there is provided a method of determining a utility function, comprising the steps of: partitioning at least one data set into at least one of an elastic class comprising a plurality of applications and having a heightened utility elasticity, a small multimedia class, and a large multimedia class, wherein the small and large multimedia classes are defined according to at least one resource usage threshold; and determining at least one form of at least one utility function, the form being tailored to the at least one of the elastic class, the small multimedia class, and at least one application within the large multimedia class.

In accordance with another aspect of the present invention, there is provided a method of determining a utility function, comprising the steps of: approximating a plurality of utility functions using a plurality of piece-wise linear utility functions; and aggregating the plurality of piece-wise linear utility functions to thereby form an aggregated utility function comprising an upper envelope function derived from the plurality of piece-wise linear utility functions, the upper envelope function comprising a plurality of linear segments, each of the plurality of linear segments having a slope having upper and lower limits.

In accordance with yet another aspect of the present invention, there is provided a method of allocating resources, comprising the steps of: approximating a first utility function using a first piece-wise linear utility function, wherein the first utility function is associated with a first resource user category; approximating a second utility function using a second piece-wise linear utility function, wherein the second utility function is associated with a second resource user category; weighting the first piece-wise linear utility function using a first weighting factor, thereby generating a first weighted utility function, the first weighted utility function representing a dependence of a weighted utility associated with the first resource user category upon a first amount of at least one resource, the first amount of the at least one resource being allocated to the first resource user category; weighting the second piece-wise linear utility function using a second weighting factor unequal to the first weighting factor, thereby generating a second weighted utility function, the second weighted utility function representing a dependence of a weighted utility associated with the second resource user category upon a second amount of the at least one resource, the second amount of the at least one resource being allocated to the second resource user category; and controlling at least one of the first and second amounts of the at least one resource such that the weighted utility associated with the first resource user category is approximately equal to the weighted utility associated with the second resource user category.

In accordance with an additional aspect of the present invention, there is provided a method of allocating network resources, comprising the steps of: using a fairness-based algorithm to identify a selected set of at least one member egress having a first amount of congestability, wherein the selected set is defined according to the first amount of congestability, wherein at least one non-member egress is excluded from the selected set, the non-member egress having a second amount of congestability unequal to the first amount of congestability, wherein the first amount of congestability is dependent upon a first amount of a network resource, the first amount of the network resource being allocated to the member egress, and wherein the second amount of congestability is dependent upon a second amount of the network resource, the second amount of the network resource being allocated to the non-member egress; and adjusting at least one of the first and second amounts of the network resource, thereby causing the second amount of congestability to become approximately equal to the first amount of congestability, thereby increasing a number of member egresses in the selected set.

### BRIEF DESCRIPTION OF THE DRAWINGS

Further objects, features, and advantages of the invention will become apparent from the following detailed description taken in conjunction with the accompanying figures showing illustrative embodiments of the invention, in which:

FIG. 1 is a flow diagram illustrating a procedure for allocating resources in accordance with the present invention;

FIG. 2 is a block diagram illustrating a network router;

FIG. 3 is a flow diagram illustrating a procedure for allocating resources in accordance with the present invention;

FIG. 4 is a flow diagram illustrating a procedure for allocating network resources in accordance with the present invention;

FIG. 5 is a flow diagram illustrating an additional procedure for allocating network resources in accordance with the present invention;

FIG. 6 is a flow diagram illustrating a procedure for performing step 506 of the flow diagram illustrated in FIG. 5;

FIG. 7 is a flow diagram illustrating an additional procedure for performing step 506 of the flow diagram illustrated in FIG. 5;

FIG. 8 is a flow diagram illustrating another procedure for performing step 506 of the flow diagram illustrated in FIG. 5;

FIG. 9 is a flow diagram illustrating a procedure for determining a utility function in accordance with the present invention;

FIG. 10 is a flow diagram illustrating an alternative procedure for determining a utility function in accordance with the present invention;

FIG. 11 is a flow diagram illustrating another alternative procedure for determining a utility function in accordance with the present invention;

FIG. 12 is a flow diagram illustrating yet another alternative procedure for determining a utility function in accordance with the present invention;

FIG. 13 is a flow diagram illustrating a further alternative procedure for determining a utility function in accordance with the present invention;

FIG. 14 is a flow diagram illustrating a procedure for allocating resources in accordance with the present invention;

FIG. 15 is a flow diagram illustrating an alternative procedure for allocating resources in accordance with the present invention;

FIG. 16 is a flow diagram illustrating another alternative procedure for allocating resources in accordance with the present invention;

FIG. 17 is a flow diagram illustrating another alternative procedure for allocating network resources in accordance with the present invention; and

FIG. 18 is a block diagram illustrating an exemplary network in accordance with the present invention;

FIG. 19 is a flow diagram illustrating a procedure for allocating resources in accordance with the present invention;

FIG. 20 is a graph illustrating utility functions of transmitted data;

FIG. 21 is a graph illustrating the approximation of a utility function of transmitted data in accordance with the present invention;

FIG. 22 is a set of graphs illustrating the aggregation of the utility functions of transmitted data accordance with the present invention;

FIG. 23 is a block diagram illustrating the aggregation of data in accordance with the present invention;

FIG. 24a is a graph illustrating utility functions of transmitted data in accordance with the present invention;

FIG. 24b is a graph illustrating the aggregation of utility functions in accordance with the present invention;

FIG. 25 is a graph illustrating the allocation of bandwidth in accordance with the present invention;

FIG. 26a is a graph illustrating an additional allocation of bandwidth in accordance with the present invention;

FIG. 26b is a graph illustrating yet another allocation of bandwidth in accordance with the present invention;

FIG. 27 is a block diagram and associated matrix illustrating the transmission of data accordance with the present invention;

FIG. 28 is a diagram illustrating a computer system in accordance with the present invention; and

FIG. 29 is a block diagram illustrating a computer section of the computer system of FIG. 28.

Throughout the figures, unless otherwise stated, the same reference numerals and characters are used to denote like features, elements, components, or portions of the illustrated embodiments. Moreover, while the subject invention will now be described in detail with reference to the figures, and in connection with the illustrative embodiments, changes and modifications can be made to the described embodiments without departing from the true scope and spirit of the subject invention as defined by the appended claims.

### DETAILED DESCRIPTION OF THE INVENTION

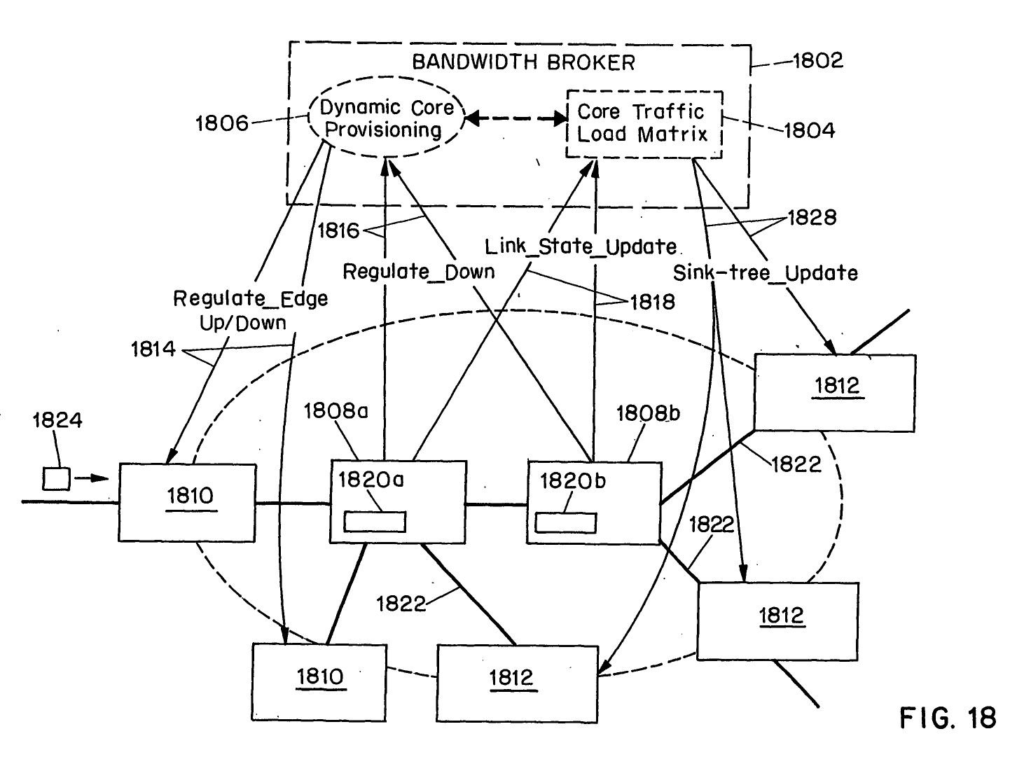

The present invention is directed to providing advantages for the allocation (a/k/a “provisioning”) of limited resources in data communication networks such as the network illustrated in FIG. 18. The network of FIG. 18 includes routing modules 1808a and 1808b, ingress modules 1810, and egress modules 1812. The ingress modules 1810 and the egress modules 1812 can also be referred to as edge modules. The routing modules 1808a and 1808b and the edge modules 1810 and 1812 can be separate, stand-alone devices.

Alternatively, a routing module can be combined with one or more edge modules to form a combined routing device. Such a routing device is illustrated in FIG. 2. The device of FIG. 2 includes a routing module 202, ingress modules 204, and egress modules 206. Input signals 208 can enter the ingress modules 204 either from another routing device within the same network or from a source within a different network. The egress modules 206 transmit output signals 210 which can be sent either to another routing device within the same network or to a destination in a different network.

Referring again to FIG. 18, a packet 1824 of data can enter one of the ingress modules 1810. The data packet 1824 is sent to routing module 1808a, which directs the data packet to one of the egress modules 1812 according to the intended destination of the data packet 1824. Each of the routing modules 1808a and 1808b can include a data buffer 1820a or 1820b which can be used to store data which is difficult to transmit immediately due to, e.g., limitations and/or bottlenecks in the various downstream resources needed to transmit the data. For example, a link 1821 from one routing module 1808a to an adjacent routing module 1808b may be congested due to limited bandwidth, or a buffer 1820b in the adjacent routing model 1808b may be full. Furthermore, a link 1822 to the egress 1812 to which the data packet must be sent may also be congested due to limited bandwidth. If the buffer 1820a or 1820b of one of the routing modules 1808a or 1808b is full, yet the routing module (1808a or 1808b) continues to receive additional data, it may be necessary to erase incoming data packets or data packets stored in the buffer (1820a or 1820b). It can therefore be seen that the network illustrated in FIG. 18 has limited resources such as bandwidth and buffer space, which can cause the loss and/or delay of some data packets. Such loss and/or delay can be highly undesirable for “customers” of the network, who can include individual subscribers, persons or organizations administering adjacent networks, or other users transmitting data into the network or receiving data from the network.

The present invention enables more effective utilization of the limited resources of the network by providing advantageous techniques for allocating the limited resources among the data packets travelling through the network. Such techniques includes a node provisioning algorithm to allocate the buffer and/or bandwidth resources of a routing module, a dynamic core provisioning algorithm to regulate the amount of data entering the network at various ingresses, an ingress provisioning algorithm to regulate the characteristics of data entering the network through various ingresses, and an egress dimensioning algorithm for regulating the amount of bandwidth allocated to each egress of the network.

In accordance with the present invention, a novel node provisioning algorithm is provided for a routing module in a network. The node provisioning algorithm of the invention controls the parameters used by a scheduler algorithm which separates data traffic into one or more queues (e.g., sequences of data stored within one or more memory buffers) and makes decisions regarding if and when to release particular data packets to the output or outputs of the router. For example, the data packets can be categorized into various categories, and each category assigned a “service weight” which determines the relative rate at which data within the category is released. Preferably, each category represents a particular “service class” (i.e., type and quality of service to which the data is entitled) of a particular customer. To illustrate, consider a first data category having a service weight of 2 and a second data category having a service weight of 3. If the buffers in a router contain data falling within each of the aforementioned categories, the scheduler will release 2 packets of category-one data for every 3 packets of category-two data. A data packet can be categorized by, e.g., the Internet Protocol (“IP”) address of the sender and/or the recipient, by the particular ingress through which the data entered the network, by the particular egress through which the data will leave the network, or by information included in the header of the packet, particularly in the 6-bit “differentiated service codepoint” (a/k/a the “classification field”). The classification field can include information regarding the service class of the data, the source of the data, and/or the destination of the data. Bandwidth allocation is generally adjusted by adjusting the relative service weights of the respective categories of data.

Data service classes can include an “expedited forwarding” (“EF”) class, an “assured forward” (“AF”) class, a “best effort” (“BE”) class and/or a “lower than best effort” (“LBE”) class. Such classes are currently in use, as will be understood by those skilled in the art.

The EF class tends to be the highest priority class, and is governed by the most stringent requirements with regard to low delay, low jitter, and low packet loss. Data to be used by applications having very low tolerance for delay, jitter, and loss are typically included in the EF class.

The AF class tends to be the next-highest-priority class below the EF class, and is governed by somewhat relaxed standards of delay, jitter, and loss. The AF class can be divided into two or more sub-classes such as an AF1 sub-class, an AF2 sub-class, an AF3 sub-class, etc. The AF1 sub-class would typically be the highest-priority sub-class within the AF class, the AF2 sub-class would have somewhat lower priority than the AF1 class, and so on. Data to be used for highly “adaptive” applications—i.e., applications which can tolerate occasional and/or moderate delay, jitter, and/or loss—are typically included in the AF class.

The BE class has a lower priority than the AF class, and in fact, generally has no requirements as to delay, jitter, and loss. The BE class is typically used to categorize data for applications which are relatively tolerant of delay, jitter and/or loss. Such applications can include, for example, web browsing.

The LBE class is generally the lowest of the classes, and may be subject to intentionally-increased delay, jitter, and/or loss. The LBE class can be used, for example, to categorize data sent by, or to, a user which has violated the terms of its service agreement—e.g., by sending and/or receiving data having traffic characteristics which do not conform to the terms of the agreement. The data of such a user can be included in the LBE class in order to deter the user from engaging in further violative behavior, or in order to deter other users from engaging in similar conduct.

During periods of heavy traffic, including during “bursts” (i.e., temporary peaks) of traffic, some data packets may experience delays due to the limited bandwidth capacity of one or more links within the network. Furthermore, if the amount of data flowing into a router continues, for a significant period of time, to exceed the capacity of the router to pass the data through to downstream components, one or more buffers within the router may become completely full, in which case, it becomes necessary to “drop” (i.e., erase or otherwise lose) data already in the buffer and/or new data being received by the router. Because of the risk of delay or loss of data, customers of the network sometimes seek to protect themselves by entering into “service level agreements” which can include guarantees such as maximum packet loss rate, maximum packet delay, and maximum delay “jitter” (i.e., variance of delay). However, it is difficult to eliminate the possibility of a violation of a service level agreement, because there is generally no guaranteed limit on the rate at which data is sent to the network, or to any particular ingress of the network, by outside sources. As a result, for most networks, there will be occasions when one or more service agreements are violated.

A node provisioning algorithm in accordance with the present invention can adjust the relative service weights of one or more categories of data in order to decrease the risk of violation of one or more service level agreements. In particular, it may be desirable to rank customers according to priority, and to decrease the risk of violating an agreement with a higher-priority customer, at the expense of increased risk of violating an agreement with a lower-priority customer. The node provisioning algorithm can be configured to leave the respective service weights unchanged unless there is a significant danger of buffer overflow, excessive delay, or other violation of one or more of the service agreements. The algorithm can measure incoming data traffic and the current size of the queue within a buffer, and can either measure the total size of the buffer or utilize already-known information regarding the size of the buffer. The algorithm can utilize the above information about incoming traffic, queue size, and total buffer size to calculate the probability of buffer overflow and/or excessive delay. There is, in fact, a trade-off between limiting the delay and reducing packet loss, because reducing the probability of the loss of a packet requires a large buffer which can become full during times of heavy traffic. The full—or partially full—buffer can introduce a delay between the time a packet arrives and the time the packet is released from the buffer. Consequently, enforcing a delay limit often entails either limiting the buffer size or otherwise causing packets to be dropped during high traffic periods in order to ensure that the queue size is limited.

The “granularity” (i.e., coarseness of resolution) of the delay limit D(i) tends to be increased by the typically long time scales of resource provisioning. The choice of D(i) takes into consideration the delay of a single packet being transmitted through the next downstream link, as well as “service time” delays—i.e., delays in transmission introduced by the scheduling procedures within the router. In addition, queuing delays can occur during periods of heavy traffic, thereby causing data buffers to become full, as discussed above. In some conventional systems, the buffer size K(i) is configured to accommodate the worst expected levels of traffic “burstiness” (i e., frequency and/or size of bursts of traffic). However, the node provisioning algorithm of the present invention does not restrict the traffic rate to the worst case traffic burstiness conditions, which can be quite large. Instead, the method of the invention uses a buffer size K(i) equal to D(i) service_rate given the delay budget D(i) at each link for class i. The dynamic node provisioning algorithm of the present invention enforces delay guarantees by dropping packets and adjusting service weights accordingly.

The choice of loss threshold P*ₗₒₛₛ(i) specified in the service level specification can be based on the behavior of the application using the data. For example, a service class intended for ordinary, data-transmission applications should not specify a loss threshold that can impact the steady-state behavior—e.g., performance—of the applications.

Such data transmission applications commonly use the well-known “transmission control protocol” (“TCP”). An exemplary TCP procedure is illustrated in FIG. 19. The sender of the data receives a feedback signal from the network, indicating the amount of network congestion and/or the rate of loss of the sender's data (step 1902). If the congestion or data loss rate exceeds a selected threshold (step 1904), the sender reduces the rate at which it is transmitting the data (step 1906). The algorithm then repeats, in an iterative loop, by returning to step 1902. If, in step 1904, the congestion or loss rate is less than the threshold amount, the sender increases its transmission rate (step 1908). The algorithm then repeats, in the aforementioned iterative loop, by returning to step 1902. As a result, the sender achieves an equilibrium in which its data transmission rate approximately matches the maximum rate that the network can accommodate.

The impact of packet loss on TCP behavior has been studied in the literature. When packet drops are rare (i.e., the non-bursty average packet drop rate Pₗₒₛₛ<P*ₗₒₛₛ), TCP can sustain its sending rate through well-known Fast-Retransmit/Fast-Recovery procedures. Otherwise, the behavior of TCP becomes driven by retransmission timeouts. The penalty of a timeout is orders of magnitude greater than that of Fast-Recovery. Studies indicate that the packet drop threshold P*ₗₒₛₛ(i) should not exceed 0.01 for data applications.

The calculation of rate adjustment in accordance with the present invention is based on a “M/M/1/K” model which assumes a Markovian input process, a Markovian output process, one server, and a current buffer size of K. A Markovian process—i.e., a process exhibiting Markovian behavior—is a random process in which the probability distribution of the interval between any two consecutive random events is identical to the distributions of the other intervals, independent of (i.e., having no cross-correlation with) the other intervals, and exponential in form. The probability distribution of a variable represents the probability that the variable has a value no greater than a selected value. An exponential distribution typically has the form P=[1−e^{-(αT-β)}], where P represents the probability that the variable is no greater than T, T represents the selected value (a time interval, in the case of a data queue), α represents an exponential constant, and β represents a shift in the distribution caused by “deterministic” (i.e., non-random) effects.

If the process is a discreet process (i.e., a process having discrete steps), rather than a continuous process, then it can be described as a “Poisson” process if the number of events (as opposed to the interval between events) occurring at a particular step exhibits the above-described exponential distribution. In the case of a Poisson process, the distribution of the number of events per step exhibits “identical” and “independent” behavior, similarly to the behavior of the interval in a Markovian process.

The Poisson hypothesis on arrival process and service time has been validated as an appropriate model for mean delay and loss calculation for exponential and bursty inputs. Because the overall network control is an iterative closed-loop control system, the impact of modeling inaccuracy can tend to increase the convergence time but does not affect the steady state operating point. Using the property that Poisson arrivals see the average packet loss probability Pₗₒₛₛ in an M/M/1/K queue is the steady state probability of a full queue, i.e.,

$${P}_{loss} = \frac{( 1 - ρ ) {ρ}^{K}}{1 - {ρ}^{K + 1}} . \qquad ( 1 )$$

where traffic intensity ρ=λs, λ is the mean traffic rate and s is the mean service time. Here K is chosen to enforce the per-node delay bound Dₘₐₓ, that is sₘₐₓ(K)=Dₘₐₓ/(K+1). sₘₐₓ(K) is the longest mean service time that does not violate the delay bound.

The average number of packets in the system, Nₛ is:

$$\begin{matrix}{N}_{S} = \frac{1 - ρ}{1 - {ρ}^{K + 1}} {\sum }_{i = 1}^{K} i {ρ}^{i} = \frac{ρ}{1 - ρ} ( 1 - ( K + 1 ) \frac{( 1 - ρ ) {ρ}^{K}}{1 - {ρ}^{K + 1}} ) & ( 2 ) \\ = \frac{ρ}{1 - ρ} ( 1 - ( K + 1 ) {P}_{loss} ) . & ( 3 )\end{matrix}$$

From Little's Theorem, the average queue length N_{q} is represented by the following equation:

$$\frac{{N}_{q}}{λ} + s = \frac{{N}_{s}}{λ} .$$

Therefore:

$${N}_{q} = \frac{ρ}{1 - ρ} ( ρ - ( K + 1 ) {P}_{loss} ) . \qquad ( 4 )$$

When

$${P}_{loss} \to 0 , {N}_{q} = \frac{{ρ}^{2}}{1 - ρ}$$

is the mean queue length of an M/M/1 queue with an infinite buffer. From Equation (1), with a given packet loss of P*ₗₒₛₛ we can calculate the corresponding traffic intensity ρ*. Given the packet loss rate of a M/M/1/K queue as Pₗₒₛₛ, the corresponding traffic intensity ρ is bounded as:

ρₐ≦ρ≦ρ_{b}, where (5)

ρ_{b}=f(K_{inf}), ρₐ=f(Kₛᵤₚ) and (6)

$$f ( z ) {Δ}_{=} {10}^{- \frac{lg ( {10}^{z} + {P}_{loss} ) - lg {P}_{loss}}{K + 1}} \qquad ( 7 )$$

K_{inf} is calculated by searching K=└zₘᵢₙ┘, . . . , └zₘₐₓ┘ until 10^{K}+1≦1/f(k)<10^{k+1}+1, and similar Kₛᵤₚ is calculated by searching K=┌zₘᵢₙ┐, . . . , ┌zₘₐₓ┐ until 10^{(k-1)}+1<1/f(k)≦10^{k}+1. Here zₘₐₓ

$$lg ( {( \frac{1}{{P}_{loss}} - K )}^{\frac{1}{K}} - 1 ) and {z}_{min} {Δ}_{=} l g ( {( \frac{1}{K {P}_{loss}} - \frac{1}{K} )}^{\frac{1}{K}} - 1 ) .$$

The bound on ρ given by (5) becomes tight very quickly as the buffer size increases because

$${10}^{- 1 / ( K + 1 )} \leq \frac{{ρ}_{a}}{{ρ}_{b}} \leq 1.$$

For example, when K=10, the relative error is less than 12%; when K=100, the relative error becomes less than 1%. It is to be noted that computation time of the preceding calculation is small because it only involves explicit formulae with the exception of the search of integer κ between └zₘᵢₙ┘ and └zₘₐₓ┘. However, this search is very short due to the tight bound of zₘᵢₙ and zₘₐₓ. For example, if Pₗₒₛₛ=10⁻³, when K=10, └zₘᵢₙ┘=└zₘₐₓ┘=−1; when K=200, └zₘᵢₙ┘=−3 and └zₘₐₓ┘=−2. If Pₗₒₛₛ=10⁻⁶, when K=10, └zₘᵢₙ┘=└zₘₐₓ┘=2; and when K=200, └zₘᵢₙ┘=└zₘₐₓ┘=0.

Given a packet loss bound P*ₗₒₛₛ(i) for a per-class queue i, a goal of the dynamic node provisioning algorithm is to ensure that the measured average packet loss rate \overline{P}ₗₒₛₛ is below P*ₗₒₛₛ(i). When \overline{P}ₗₒₛₛ>γₐP*ₗₒₛₛ(i), the algorithm reduces the traffic intensity either by increasing the service weight of a particular queue—and reducing the service weights of lower priority queues—or by using a Regulate_Down signal to instruct the dynamic core provisioning algorithm (discussed in further detail below) to reduce the allocated bandwidth at the appropriate ingresses. When \overline{P}ₗₒₛₛ<γ_{b}P*ₗₒₛₛ(i), the dynamic node provisioning algorithm increases traffic intensity by first decreasing the service weight of a selected queue. The release of previously-occupied bandwidth is signaled (via a Link_State signal) to the dynamic core provisioning algorithm, which increases the allocated bandwidth at the ingresses.

γₐ and γ_{b}, where γ_{b}<γₐ<1, are designed to add control hysteresis in order to increase the stability of the control loop. When the loss bound P*ₗₒₛₛ(i) is small, merely counting rare packet loss events can introduce a large bias. Therefore, the algorithm uses the average queue length N_{q}(i) for better measurement accuracy. Given the upper loss threshold γₐP*ₗₒₛₛ(i), the corresponding upper threshold on traffic intensity ρ^{sup}(i) can be calculated using ρ_{b} in Equation (6), and subsequently the upper threshold on the average queue length N_{q}^{sup}(i) can be calculated using Equation (4). Similarly, given γ_{b}P*ₗₒₛₛ(i), the lower threshold of ρ^{inf}(i) can be calculated using ρₐ in (6), and then N_{q}^{inf}(i) can also be determined.

When the queue is not fully loaded—i.e., when the packet arrival rate equals the packet departure rate—the measured average queue length \overline{N}_{q}(i), the packet loss rate \overline{P}ₗₒₛₛ(i), and the packet arrival rate \overline{λ}(i) can be used to calculate the current traffic intensity \overline{ρ}(i) by applying the following equation transformed from Equation (4):

$$\overline{ρ} = \frac{1}{2} ( \sqrt{{( {\overline{N}}_{q} - ( K + 1 ) {P}_{loss} )}^{2} + 4 {\overline{N}}_{q} - ( {\overline{N}}_{q} - ( K + 1 ) {P}_{loss} )} ) . \qquad ( 8 )$$

On the other had, when the queue is overloaded—i.e., when \overline{λ}(i) exceeds the packet departure rate, \overline{λ}(i)=\overline{ρ}(i)/(packet departure rate).

The node provisioning algorithm in accordance with the present invention then applies the following control conditions to regulate the traffic intensity \overline{ρ}(i):

1. If \overline{N}_{q}(i)>N_{q}^{sup}(i), reduce traffic intensity to \tilde{ρ}(i) by either increasing service weights or reducing arrival rate by a multiplicative factor βᵢ;

2. If \overline{N}_{q}(i)<N_{q}^{inf}(i), increase traffic intensity to \tilde{ρ}(i) by either decreasing service weights or increasing the arrival rate by a multiplicative factor βᵢ.

In both cases, the target traffic intensity \tilde{ρ}(i) is calculated as

$$\tilde{ρ} ( i ) = \frac{1}{2} ( {ρ}^{sup} ( i ) + {ρ}^{inf} ( i ) ) , \qquad ( 9 )$$

and βᵢ is

$${β}_{i} = \frac{\tilde{ρ} ( i )}{\overline{ρ} ( i )} . \qquad ( 10 )$$

The error incurred by using an approximation (from Equation 6) to calculate ρ^{sup}(i) and ρ^{inf}(i) is small because the error is bounded by 10^{1/(K+1)}.

Using the above-described control decision criteria and formulation of the modification factor β, the node algorithm can make a choice between increasing service one or more weights or reducing the data arrival rate during congested or idle periods. This decision is simplified by limiting the service model to strict priority classes—i.e., a higher-priority class can “steal” bandwidth from a lower-priority class until a minimum bandwidth bound (e.g., a minimum service weight wᵢ^{min}) of the lower priority class is reached. In addition, local service weights can be adjusted before reducing the arrival rate. By adjusting the local service weights first, it can be possible to avoid the need to reduce the arrival rate. This can be beneficial, because reducing the arrival rate can tend to require a network-wide adjustment of traffic conditioners at the edges. An increase in the arrival rate, if appropriate, is performed by a periodic network-wide rate re-alignment procedure, which is part of the core provisioning algorithm (discussed below) which operates over longer time scales. The node provisioning algorithm produces rate reduction very quickly, if rate reduction is needed. In contrast, the algorithm's response to the need for a rate increase to improve utilization is delayed. The differing time constants reduce the likelihood of oscillation in the rate allocation control system.

For simplification of notation it can be helpful to assume that for the commonly used, class-based, Weighted Fair Queuing (“WFQ”) algorithm—in which packets from each queue are served at a rate corresponding to the queue's relative service weight—the total of the service weights of each scheduler is an integer W>0, and that each queue has a service weight of wᵢ≧wᵢ^{min}≧0 which is also an integer. Σᵢ₌₁^{N-1}wᵢ≦W, and w_{N}=W−Σᵢ₌₁^{N-1}wᵢ, i.e., the lowest priority class N takes all the remaining service weights. In addition, the algorithm tracks the set of active queues A⊂{1, 2, . . . , N}.

The node algorithm distributes the service weights {wᵢ} such that the measured queue size

$${\overline{N}}_{q} ( i ) ∈ [ {N}_{q}^{inf} ( i ) , {N}_{q}^{sup} ( i ) ] .$$

The adjustment is prioritized based on the order of the service class; that is, the adjustment of a class i queue will only affect the class j queues where j>i. The pool of remaining service weights is denoted as W+. Because the total amount of service weights is fixed, W+ can, in some cases, reach zero before a class gets any service weights. In such cases, the node algorithm triggers rate reduction at the edge routers.

The pseudo code for the node algorithm is shown below.

dynamic_node_provisioning( )
// Initialization: calculates queue threshold and traffic
intensity
calculate N_{q}^{sup}(i),N_{q}^{inf}(i) and \tilde{p}(i)
// Local Measurement of queue length, loss and arrival rate
measure \overline{N}_{q}(i),\overline{P}ₗₒₛₛ(i) and λᵢ, and updated A
// On packet arrival
IF \overline{N}_{q}(i)>N_{q}^{sup}(i) OR \overline{N}_{q}(i)<N_{q}^{inf}(i)

IF time_since_last_invocation>UPDATE_INTERVAL

| adjust_weight_threshold( ) | |
|---|---|
| adjust_weight_threshold( ) | |
| W⁺=W−Σ_{i∈A}wᵢ^{min} | // W⁺: service weight pool |
| FOR i=1,...,N−1 AND i∈A | // class priority order |

| (*) | IF \overline{N}_{q}(i)>N_{q}^{sup}(i) OR \overline{N}_{q}(i)<N_{q}^{inf}(i) |
|---|---|
| | // cross the upper or lower thresholds |
| | calculate βᵢ by Eqn (10) |
| | ELSE |

βᵢ = 1

END IF

| IF w⁺ ≧ wᵢ/βᵢ | // enough weights in the |
|---|---|
| | pool |
| wᵢ^{new}=wᵢ/βᵢ+wᵢ^{min} | // update service weights |

λᵢ^{new}= λᵢ

ELSE

Wᵢ^{new}=min {W⁺,wᵢ/βᵢ}+wᵢ^{min}
λᵢ^{new}=βᵢ(wᵢ^{new}/wᵢ)λᵢ

| END IF | |
|---|---|
| c(i)= \overline{λ}ᵢ− λᵢ^{new} | // the amount of class i |

traffic to be reduced

IF K(i)>D(i) * (line_rate / mean_pkt_size)* (wᵢ^{new}/W)

// delay bound could be violated, reduce queue size
K(i)=D(i) * (line_rate / mean_pkt_size)*(wᵢ/W)
// return the adjustment one more time under new K(i)
// the second pass won't enter here
GOTO line (*)

END IF

| | |
|---|---|
| wᵢ=wᵢ^{new} | // commit change |

W⁺−=(wᵢ−wᵢ^{min})

END FOR

| w_{N}=W−W⁺ | |
|---|---|
| Regulate_Down({c(i)}) | // throttle back to edge |

conditioner

The node algorithm can neglect the correlation between service weight wᵢ and the queue size K(i) because K(i) is changed only after a new service weight is calculated. Consequently, the effect of service weight adjustment can be amplified. For example, if the service weight is reduced to increase packet loss above a selected threshold, queue size is reduced by the same proportion, which further increases the packet loss. This error can be alleviated by running the adjustment algorithm one more time (i.e., the GOTO line in pseudo code) with the newly reduced buffer size. In addition, setting the lower and upper loss thresholds apart from each other also improves the algorithm's tolerance to calculation errors.

The algorithm simplifies calculation of wᵢ by assuming that the sum of the service weights of active queues is equal to the total service weight—i.e., Σ_{iεA}wᵢ=W. When the scheduler is under-loaded, this becomes an approximation. The impact on service quality is negligible because any sustained congestion will push Σ_{iεA}wᵢ to W.

The minimum service weight parameter wᵢ^{min} can be used to guarantee a minimum level of service for a class. When a queue has a single class and is under-loaded, changing the service weight does not affect the actual service rate of this class. Therefore, in this case, the node algorithm would continuously reduce the service weight by multiplying βᵢ<1. Introducing wᵢ^{min} avoids this potentially undesirable result.

The function Regulate_Down( ) reduces per-class bandwidth at edge traffic conditioners such that the arrival rate at a target link is reduced by c(i). This rate reduction is induced by the overload of a link. In addition, it can be desirable to coordinate bandwidth increases at the edge conditioners. Algorithms to support these goals, while maintaining important networking properties such as efficiency and fairness in bandwidth distribution, are discussed in further detail below.

The performance of the node provisioning algorithm can be dependent on the measurement of queue length \overline{N}_{q}(i), packet loss \overline{P}ₗₒₛₛ(i), and arrival rate \overline{λ}ᵢ for each class. An exponentially-weighted moving average function can be used:

\overline{X}^{new}(i)=(1−e^{-Tk/τ})X(i)+e^{-Tk/τ}\overline{X}^{old}(i) (11)

where Tₖ denotes the interval between two consecutive updates (on packet arrival and departure), τ is the measurement window, and X represents \overline{N}_{q}, \overline{P}ₗₒₛₛ, or \overline{λ}.

τ is the same as the update_interval in the pseudo code which determines the operational time scale of the algorithm. In general, its value is preferably one order of magnitude greater than the maximum round trip delay across the core network, in order to smooth out the traffic variations due to the flow control algorithm of the transport protocol. The interval τ can, for example, be set within a range of approximately 300-500 msec.

One relevant consideration relates to measuring instantaneous packet loss Pₗₒₛₛ. An additional measurement window τ₁ can be used to ensure the statistical reliability of packet arrival and drop counters. τ₁ is preferably orders of magnitude larger than the product of {P*ₗₒₛₛ(i)} and the mean packet transmission time, in order to provide improved statistical accuracy in the calculation of packet loss rate. The algorithm can use a sliding window method with two registers, in which one register stores the end result in the preceding window and the other register stores the current statistics. In this way, the actual measurement window size increases linearly between τ₁ and 2τ₁ in a periodic manner. The instantaneous packet loss is then calculated by determining the ratio between packet drops and arrivals, each of which is a sum of two measurement registers.

In addition, if the traffic into a router increases too much, too quickly, and/or too unpredictably for the node provisioning software to adjust the allocation of node router resources to accommodate the traffic, the node provisioning algorithm can send an alarm signal (a/k/a “Regulate_Down” signal) to a dynamic core provisioning system, discussed in further detail below, directing the core provisioning system to reduce traffic entering the network by sending an appropriate signal—e.g., a “Regulate_Edge_Down” signal—to one or more ingress modules. Furthermore, the node provisioning algorithm can periodically send status updates (a/k/a “link state updates”) to the core provisioning system.

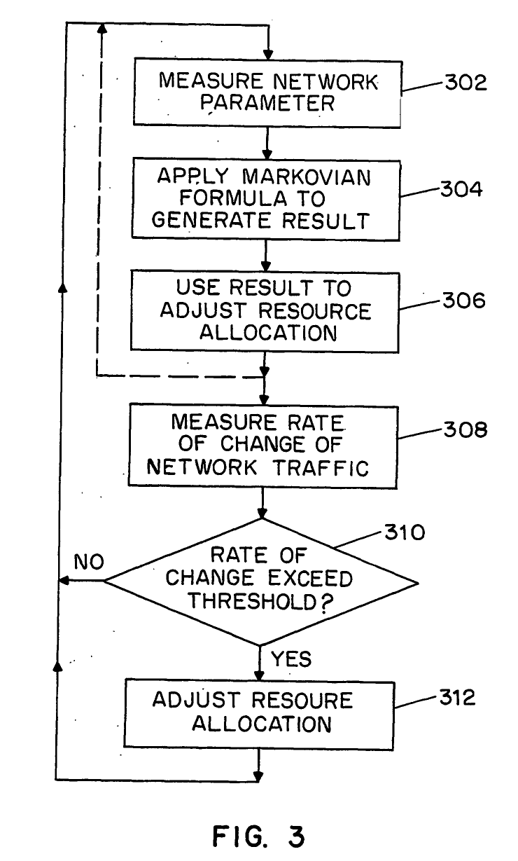

FIG. 3 illustrates an example of a dynamic node provisioning procedure in accordance with the invention. The node provisioning system first measures a relevant network parameter, such as the amount of usage of a network resource, the amount of traffic passing through a portion of the network such as a link or a router, or a parameter related to service quality (step 302). Preferably, the parameter is either delay or packet loss, both of which are indicators of service quality. The aforementioned amount of network resource usage can include, for example, one or more lengths of queues of data stored in one or more buffers in the network. The service quality parameter can include, for example, the likelihood of violation of one or more terms of a service level agreement. Such a probability of violation can be related to a likelihood of packet loss or likelihood of excessive packet delay. The algorithm applies a Markovian formula—preferably having the form of Equation (1), above—to the network parameter in order to generate a mathematical result which can be related to, e.g., the probability of occurrence of a full buffer, or other overuse of a network resource such as memory or bandwidth capacity (step 304). Preferably, the mathematical result represents the probability of a full buffer.

Such a Markovian formula is based on at least one Markovian or Poisson assumption regarding the behavior of the queue in the buffer. In particular, the Markovian formula can assume that packet arrival and/or departure processes of the buffer exhibit Markovian or Poisson behavior, discussed in detail above.

The system uses the result of the Markovian formula to determine whether, and in what manner, to adjust the allocation of the resources in the system (step 306). For example, service weights associated with various categories of data can be adjusted. Categories can correspond to, e.g., service classes, users, data sources, and/or data destinations. The procedure can be performed dynamically (i.e., during operation of the system), and can loop back to step 302, whereupon the procedure is repeated. Optionally, before looping back to step 302, the system can measure the rate of change of traffic travelling through one or more components of the system (step 308). If this rate exceeds a threshold (step 310), the system can adjust the allocation of resources in order to accommodate the traffic change (step 312), whereupon the algorithm loops back to step 302. If the rate of change does not exceed the aforementioned threshold (in step 310), the algorithm simply loops back to step 302 without making another adjustment.

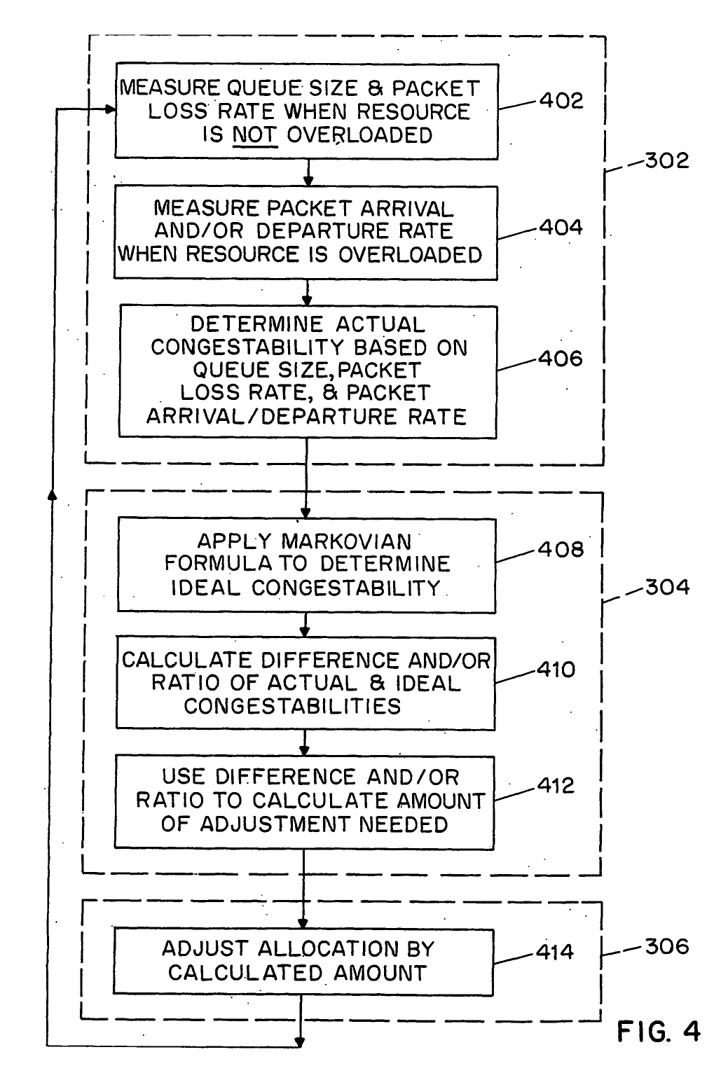

FIG. 4 illustrates an additional method of allocating network resources in accordance with the invention. In the algorithm of FIG. 4, the queue size and packet loss rate of the router are measured when the bandwidth and/or buffer are not overloaded (step 402). The packet arrival rate and/or the packet departure rate is measured when one of the aforementioned network resources is overloaded (step 404). The system gauges the tendency of the router to become congested using the queue size, the packet loss rate, and the packet arrival and/or departure rate (step 406). The Markovian formula is used to determine the ideal congestability of the router (step 408). The system compares the actual and ideal congestabilities of the router by calculating their difference and/or their ratio (step 410). The difference and/or ratio is used to determine how much the allocation of the resources in the router should be adjusted (step 412). The allocation is adjusted accordingly (step 414). The algorithm then loops back to step 402. It is to be noted that steps 402, 404 and 406 of FIG. 4 can be viewed as corresponding to step 302 of FIG. 3. Steps 408, 410 and 412 of FIG. 4 can be viewed as corresponding to step 304 of FIG. 3. Step 414 of FIG. 4 can be viewed as corresponding to step 306 of FIG. 3.

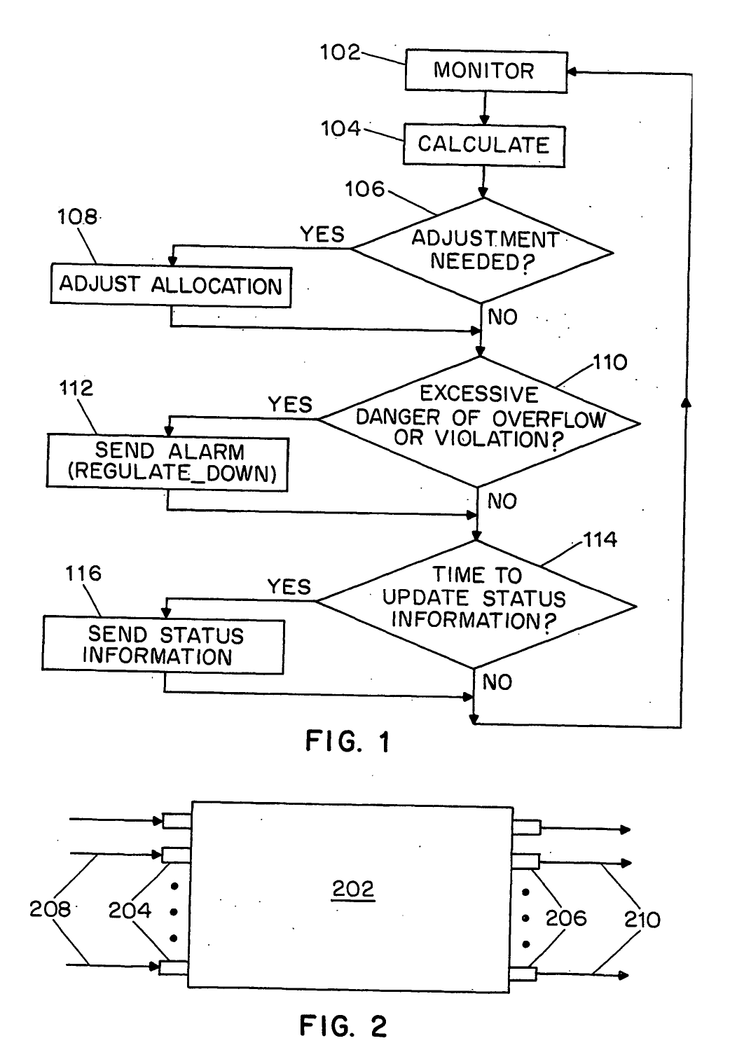

A further method of allocating network resources is illustrated in FIG. 1. The procedure illustrated in FIG. 1 includes a step in which the system monitors a network parameter related to network resource usage, amount of network traffic, and/or service quality (step 102). Preferably, the network parameter is either delay or packet loss. The system uses the network parameter to calculate a result indicating the likelihood of overuse of resources (e.g., bandwidth or buffer space, preferably buffer space) or, even more preferably, violation of one or more rules which can correspond to requirements or other goals set forth in a service level agreement (step 104). If an adjustment is required in order to avoid violating one of the aforementioned rules (step 106), the system adjusts the allocation of resources appropriately (step 108). The preferred rule is a delay-maximum guarantee. Regardless of whether an adjustment is made at this point, the system evaluates whether there is an extremely high danger of buffer overflow or violation of one of the aforementioned rules (step 110). The presence of such an extremely high danger can be detected by comparing the probability of overflow or violation to a threshold value. If the extreme danger is present, the system sends an alarm (i.e., warning) signal to the core provisioning algorithm (step 112). Regardless of whether such an alarm is needed, the system periodically sends updated status information to the core provisioning algorithm (steps 114 and 116). The status information can include, e.g., information related to the use and/or availability of one or more network resources such as memory and/or bandwidth capacity, and can also include information related to other network parameters such as queue size, traffic, packet loss rate, packet delay, and/or jitter—preferably packet delay. The algorithm ultimately loops back to step 102 and is repeated.

As discussed above, a system in accordance with the invention can include a dynamic core provisioning algorithm. The operation of such an algorithm can be explained with reference to the exemplary network illustrated in FIG. 18. The dynamic core provisioning algorithm 1806 can be included as part of a bandwidth broker system 1802, which can be computerized or can be administered by a human or an organization. The bandwidth broker system 1802 includes a load matrix storage device 1804 which stores information about a core traffic load matrix, including the usage and status of the various components of the system. The bandwidth broker system 1802 ensures effective communication among multiple networks, including outside networks. The bandwidth broker system 1802 communicates with customers and bandwidth brokers of other networks, and can negotiate service level agreements with the other customers and bandwidth brokers, which can be humans or machines. In particular, negotiation and agreement among bandwidth brokers (a/k/a/ “peering”) can be done by humans or by machine.

The load matrix storage device 1804 periodically receives link state update signals 1818 from routers 1808a and 1808b within the network. The load matrix storage device 1804 can also communicate information about the matrix—particularly, how much data from each ingress is being sent to each egress—in the form of Sync-tree_Update signals 1828 which can be sent to various egresses 1812 of the network.

The dynamic core provisioning algorithm 1806 can receive Regulate_Down signals 1816 from the routers 1808a and 1808b, and can respond to these signals 1816 by sending regulation signals 1814 to the ingresses 1810 of the network. If a Regulate_Down signal 1816 is received by the dynamic core provisioning algorithm 1806, the algorithm 1806 sends a Regulate_Edge_Down signal 1814 to the ingresses 1810, thereby controlling the ingresses to reduce the amount of incoming traffic. If no Regulate_Down signal 1816 is received for a selected period of time, the dynamic core provisioning algorithm 1806 sends a Regulate_Edge_Up signal to the ingresses 1810.

The dynamic core provisioning algorithm can use the load matrix information to determine which of the ingresses 1810 are sources of congestion in the various links of the network. The dynamic core provisioning algorithm 1806 can then reduce traffic entering through those ingresses by sending instructions to the traffic conditioners of the appropriate ingresses. The ingress traffic conditioners, discussed in further detail below, can reduce traffic from selected categories of data, which can correspond to selected data classes and/or customers.

It is to be noted that the use of link state updates to monitor the network matrix can typically involve response times of one or more hours. The link state update signals typically occur with time periods ranging from several seconds to several minutes. The algorithm typically averages these signals with a time constant approximately ten times longer than the update period.

In contrast, a Regulate_Down (i.e., alarm) signal is used when rapid results are required. Typically, the dynamic core provisioning algorithm can respond with a delay of several milliseconds or less. The terms of a service level agreement with a customer will typically be based, in part, on how quickly the network can respond to an alarm signal. For example, depending upon how much delay might accrue, or how many packets or bits might be lost, before the algorithm can respond to an alarm signal, the service level agreement can guarantee service with no more than a maximum amount of down time, no more than a maximum number of lost packets or bits, and/or no more than a maximum amount of delay in a particular time interval.

The service level agreement typically defines one or more categories of data. Categories can be defined according to attributes such as, for example, service class, user, path through the network, source (e.g., ingress), or destination. Furthermore, a category can include an “aggregated” data set, which can comprise data packets associated with more than one sub-category. In addition, two or more aggregates of data can themselves be aggregated to form a second-level aggregate. Moreover, two or more second-level aggregates can be aggregated to form a third-level aggregate. In fact, there need not be any particular limit to the number of levels in such a hierarchy of data aggregates.

Once the categories are defined, the core provisioning algorithm can regulate traffic on a category-by-category basis. In the most common configuration, once a category is defined by the service level agreement, the core provisioning algorithm generally does not specifically regulate any sub-categories within the pre-defined categories, unless the sub-categories are also defined in the service level agreement. The category-by-category rate reduction procedure of the dynamic core provisioning algorithm can comprise an “equal reduction” procedure, a “branch-penalty-minimization” procedure, or a combination of both types of procedure.

In the “equal reduction” procedure, the algorithm detects a congested link and determines which categories of data are contributing to the congestion. The algorithm reduces the rate of transmission of all of the data in each contributing category. The total amount of data in each data category is reduced by the same reduction amount. The algorithm continues to reduce the incoming data in the contributing categories until the congestion is eliminated. It is to be noted that it is possible for a category to contribute traffic not only to the congested link, but also to other, non-congested links in the system. In reducing the transmission rate of each category, the algorithm typically does not distinguish between the data travelling to the congested link and the data not travelling to the congested link, but merely reduces all of the traffic contributed by the category being regulated. The equal reduction policy can be considered a fairness-based rule, because it seeks to allocate the rate reduction “fairly”—i.e., equally—among categories. In particular, the above-described method of equal reduction of the traffic of all categories having data sent to a congested link can be referred to as a “min-max fair” algorithm.

In the “branch-penalty-minimization” procedure, the algorithm seeks to reduce the “penalty” (i.e., disadvantage) imposed on traffic directed toward non-congested portions (e.g., nodes, routers, and/or links) of the network Such a branch-penalty-minimization rule is implemented by first limiting the total amount of data within a first category having the largest proportion of its data (compared to all other categories) directed at a congested link or router. The algorithm reduces the total traffic in the first category until either the congestion in the link is eliminated or the traffic in the first category has been reduced to zero. If the congestion has not yet been eliminated, the algorithm identifies a second category having the second-highest proportion of its data directed at the congested link.

Similarly to the case of the first data category, the total amount of traffic in the second category is reduced until either the congestion is eliminated or the traffic in the second category has been reduced to zero. If the congestion still has not been eliminated, the algorithm proceeds to similarly reduce and/or eliminate the traffic in the remaining categories until the link is no longer congested.

Regardless of whether an equal reduction procedure or a branch-penalty-minimization procedure is being used, given the measured core traffic load A and the required bandwidth reduction

$$\{ - {c}_{l}^{δ} ( i ) \}$$

at link l for class i, the allocation procedure Regulate_Down({c(i)}) seeks to find the edge bandwidth reduction vector −u^{δ}=−[u^{δ}(1) [symbol] u^{δ}(2) [symbol] . . . [symbol] u^{δ}(J)]^{T} such that: aₗ,.(j)*u^{δ}(j)=cₗ^{δ}(j), where 0≦uᵢ^{δ}≦uᵢ.

When a_{l,}. has more than one nonzero coefficient, there is an infinite number of solutions satisfying the above equation. The choice of solution depends on whether the algorithm is using the equal reduction procedure, the branch-penalty-minimization procedure, or a combination of both. The chosen procedure is executed repeatedly following the order from class J to 1. For clarity, the class (j) notation is dropped for this calculation, since the operations are the same for all classes.

The policy for edge rate reduction is optimized differently depending on which type of procedure is being used. The equal reduction procedure, in the general case, seeks to minimize the variance of the rate reduction amounts, the sum of the reduction amounts, or the sum of the absolute values of the reduction amounts, among various data categories. In the variance-minimization case, minΣᵢ₌₁ⁿ(uᵢ^{δ}−(Σᵢ₌₁ⁿuᵢ^{δ})/n)² with constraints 0≦uᵢ^{δ}uᵢ and Σᵢ₌₁ⁿa_{l,i}uᵢ^{δ}=cₗ^{δ}. The solution for the variance-minimization case is:

u_{σ(1)}^{δ}=u_{σ(1)}, . . . , u_{σ(k-1)}^{δ}=u_{σ(k-1)}, and

$${u}_{σ ( k )}^{δ} = … = {u}_{σ ( n )}^{δ} = \frac{{c}_{l}^{δ} - {{\sum }^{k - 1}}_{i = 1} {a}_{l , σ ( i )} {u}_{σ ( i )}}{{{\sum }^{n}}_{i = k} {a}_{l , σ ( i )} {u}_{σ ( i )}} ,$$

where {σ(1), σ(2), . . . σ(n)} is a permutation of {1, 2, . . . , n} such that u_{σ(i)}^{δ} is sorted in increasing order, and k is chosen such that:

$${\sum }_{i = 1}^{k - 1} {a}_{l , σ ( i )} {u}_{σ ( i )} < {c}_{l}^{δ} \leq {\sum }_{i = 1}^{k} {a}_{l , σ ( i )} {u}_{σ ( i )} .$$

If a branch-penalty-minimization procedure is chosen, the total amount of branch penalty is Σᵢ₌₁ⁿ(1−a_{l,i})uᵢ^{δ} since (1−a_{l,i}) is the proportion of traffic not passing through the congested link. Therefore minimizing the branch penalty is equivalent to

$$min {\sum }_{i = 1}^{n} ( 1 - {a}_{1 , i} ) {u}_{i}^{δ} ⇔ min {\sum }_{i = 1}^{n} {u}_{i}^{δ}$$

with constraints 0≦uᵢ^{δ}≦uᵢ and Σᵢ₌₁ⁿa_{l,i}uᵢ^{δ=c}ₗ^{δ}. The solution to this is to shuffle {1, 2, . . . , n} to {σ(1), σ(2), . . . σ(n)} such that a_{l,σ(i)} is sorted in decreasing order; and to sequentially reduce u_{σ(i)} to zero following the order of σ(i) until the total reduction is equal to cₗ^{δ}.

It can be particularly advantageous to employ a method which combines aspects of both the equal reduction procedure and the branch-penalty-minimization procedure. However, at first glance, the goals of equalizing rate reduction and minimizing branch penalty appear to impose conflicting constraints. The equal reduction procedure seeks to provide the same amount of reduction to all users. In contrast, the branch-penalty-minimization procedure, at each step, depletes the bandwidth of the category with the largest proportion of its traffic passing through the congested link. To balance these two competing goals, the core provisioning algorithm policy can minimize the sum the object functions of both policies, where the object function associated with each policy represents a quantitative indication of how well that policy is being served:

$$min \{ {\sum }_{i = 1}^{n} {( {u}_{i}^{δ} - ( {\sum }_{i = 1}^{n} {u}_{i}^{δ} ) / n )}^{2} + {( {\sum }_{i = 1}^{n} {u}_{i}^{δ} )}^{2} / n \} ,$$

with constraints that

[a_{l,1}a_{l,2} . . . a_{l,n}]*[u₁^{δ}u₂^{δ} . . . uₙ^{δ}]^{T}=cₗ^{δ} and 0≦uᵢ^{δ}≦uᵢ, i=1, . . . n.

The solution to the minimization problem (15) is

[u₁^{δ}u₂^{δ} . . . uₙ^{δ}]^{T}=[a_{l,1}a_{l,2} . . . a_{l,n}]⁺*cₗ^{δ},

where [ . . . ]⁺ is the Penrose-Moore (P-M) matrix inverse that always exists.

The P-M inverse of an n×1 vector a is a 1×n vector a⁺ where a⁺=aᵢ/(Σᵢ₌₁ⁿaᵢ²).

The formulation of the object function for P-M inverse reduction leads to the property that the performance of P-M inverse reduction is in-between equal reduction and branch-penalty-minimization. In terms of equality of reduction, it is better than branch-penalty-minimization, and in terms of minimizing branch-penalty, it is better than equal reduction.

The core provisioning algorithm can also perform a “rate alignment” procedure which allocates bandwidth to various data categories so as to fully utilize the network resources. In the rate alignment procedure, the most congestable link in the system is determined. In addition, the algorithm determines which categories of data include data which are sent to the most congestable link. Bandwidth is allocated, in equal amounts, to each of the data categories that send data to the most congestable link, until the link becomes fully utilized. At this point, no further bandwidth can be allocated to the categories sending traffic to the most congestable link, because additional bandwidth in these categories would cause the link to become over-congested. Therefore, the algorithm considers all of the data categories which do not send data to the most congestable link, and determines which of these remaining categories send data to the second most congestable link. Bandwidth is then allocated to this second set of categories, in equal amounts, until the second most congestable link is fully utilized. The procedure continues until either every link in the network is fully utilized or there are no more data categories which do not send data to links which have already been filled to capacity.

The edge rate alignment algorithm tends to involve increasing edge bandwidth, which can make the operation more difficult than the reduction operation. The problem is similar to that of multi-class admission control because it involves calculating the amount of bandwidth cₗ(i) offered at each link for every service class. Rather than calculating cₗ(i) simultaneously for all the classes, a sequential allocation approach is used. In this case, the algorithm waits for an interval (denoted SETTLE_INTERVAL) after the bandwidth allocation of a higher-priority category. This allows the network routers to measure the impact of the changes, and to invoke Regulate_Down( ) if rate reduction is needed. The procedure is performed on a per-category (i.e., category-by-category) basis and follows the decreasing order of allocation priority using the following operation:

| | |
|---|---|
| FOR i = 1, ... ,N | // class priority order |

| | |
|---|---|
| (1) | calculate c(i) with the link-average method |
| (2) | max-min allocation with constraint A(i)u(i)≦c(i) |
| (3) | wait for SETTLE_INTERVAL |

END FOR

Step (1) is a modification of the first part of the dynamic node provisioning algorithm

calculate cₗ(j)
$\begin{matrix}calculate {N}_{q}^{sup} ( j ) , {N}_{q}^{inf} ( j ) and \tilde{ρ} ( j ) \\ get measurement {\overline{N}}_{q} ( j ) , {\overline{P}}_{loss} ( j ) and {λ}_{j} , track A\end{matrix}$
// starts from the remaining amount of service weights
${W}^{+} = W - {\sum }_{i ∈ A : i = 1}^{j - 1} {w}_{i} - {\sum }_{i ∈ A : i = j}^{N} {w}_{i}^{min}$

$// {w}_{i}^{min} guarantees that {W}^{+} > 0$

$IF {\overline{N}}_{q} ( j ) > {N}_{q}^{sup} ( j ) OR {\overline{N}}_{q} ( j ) < {N}_{q}^{inf} ( j )$

calculate βᵢ by Eqn (10)

ELSE

βⱼ = 1

END IF
${c}_{l} ( j ) = {β}_{j} {\overline{λ}}_{j} ( \frac{{w}^{+} + {w}_{j}^{min}}{w} ) / ( \frac{{w}_{j}}{{\sum }_{i ∈ A} {w}_{i}} )$

$// \frac{{w}_{j}}{{\sum }_{i ∈ A} {w}_{i}} : current service portion ,$

$\frac{{w}^{+} + {w}_{j}^{min}}{w} : maximum service portion$

$\begin{matrix}IF {c}_{l} ( j ) > ( line\_rate - {\sum }_{i = 2}^{j - 1} {\overline{λ}}_{i} ) \\ {c}_{l} ( j ) = ( line\_rate - {\sum }_{i = 1}^{j - 1} {\overline{λ}}_{i} ) // link capacity constraint\end{matrix}$
ENDIF
RETURN cₗ(j)

In accordance with the present invention, each ingress of a network can be controlled by an algorithm to regulate the characteristics of data traffic entering the network through the ingress. Data traffic can be divided into various categories, and a particular amount of bandwidth can be allocated to each category. For example, data packets can be categorized by source, class (i.e., the type of data or the type of application ultimately using the data), or destination. A utility function can be assigned to each category of data, and the bandwidth can be allocated in such a way as to maximize the total utility of the data traffic. In addition, the bandwidth can be allocated in such a way as to achieve a desired level or type of fairness. Furthermore, the network can allocate a fixed amount of bandwidth to a particular customer-which may include an individual or an organization—and dynamically control the bandwidth allocated to various data categories of data sent by the customer. In addition to categorizing the data by class—such as the EF, AF, BE, and LBE classes discussed above—an algorithm in accordance with the present invention can also categorize the data according to one or more sub-groups of users within a customer organization.

For example, consider a customer organization comprising three groups: group A, group B, and group C. Each group generates varying amounts of EF data and AF data. EF data has a different utility function for each of groups A, B, and C, respectively. Similarly, AF data has a different utility function for each of groups A, B, and C, respectively. The ingress provisioning algorithm of the present invention can monitor the amounts of bandwidth allocated to various classes within each of the groups within the organization, and can use the utility functions to calculate the utility of each set of data, given the amount of bandwidth allocated to the data set. In this example, there are a total of six data categories, two class-based categories for each group within the organization. The algorithm uses its knowledge of the six individual utility functions to determine which of the possible combinations of bandwidth allocations will maximize the total utility of the data, given the constraint that the organization has a fixed amount of total bandwidth available. If the current set of bandwidth allocations is not one that maximizes the total utility, the allocations are adjusted accordingly.

In an additional embodiment of the ingress provisioning algorithm, a fairness-based allocation can be used. In particular, the algorithm can allocate the available bandwidth in such a way as to insure that each group within the organization receives equal utility from its data.

The above described fairness-based allocation is a special case of a more general procedure in which each group within an organization is assigned a weighting (i.e., scaling) factor, and the utility of any given group is multiplied by the weighting factor before the respective utilities are compared. The weighting factors need not be normalized to any particular value, because they are inherently relative. For example, it may be desirable for group A always to receive 1.5 times as much utility as groups B and C. In such a case, group A can be assigned a weighting factor of 1.5, and groups B and C can each be assigned a weighting factor of 1. Alternatively, because the weighting factors are inherently relative, the same result would be achieved if group A were assigned a weighting factor of 3 and groups B and C were each assigned a weighting factor of 2. In the general case of the fairness-based ingress provisioning algorithm, the utilities of each of groups A, B and C is multiplied by the appropriate weighting factor to produce a weighted utility for each of the groups. The weighted utilities are than compared, and the bandwidth allocations and/or service weights are adjusted in order to ensure that the weighted utilities are equal.

In accordance with an additional aspect of the ingress provisioning algorithm, multiple levels of aggregation can be used. For example, a plurality of categories of data can be aggregated, using either of the above-described, utility-maximizing or fairness-based algorithms, to form a first aggregated data category. A second aggregated data category can be formed in a similar fashion. The first and second aggregated data categories can themselves be aggregated to form a second-level aggregated category. In fact, more than two aggregated categories can be aggregated to form one or more second-level aggregated data categories. Furthermore, there is no limit to the number of levels of aggregation that can be used. At each level of aggregation, either a utility-maximizing aggregation procedure or a fairness-based aggregation procedure can be used, and the method of aggregation need not be the same at each level of aggregation. In addition, at any particular level of aggregation, the data categories can be based on class, source, destination, group within a customer organization, association with one of a set of competing organizations, and/or membership in a particular, previously aggregated category.

Each packet of data sent through the network can be intended for use by a particular application or type of application. The utility function associated with each type of application represents the utility of the data as a function of the amount of bandwidth or other resources allocated to data intended for use by that type of application.

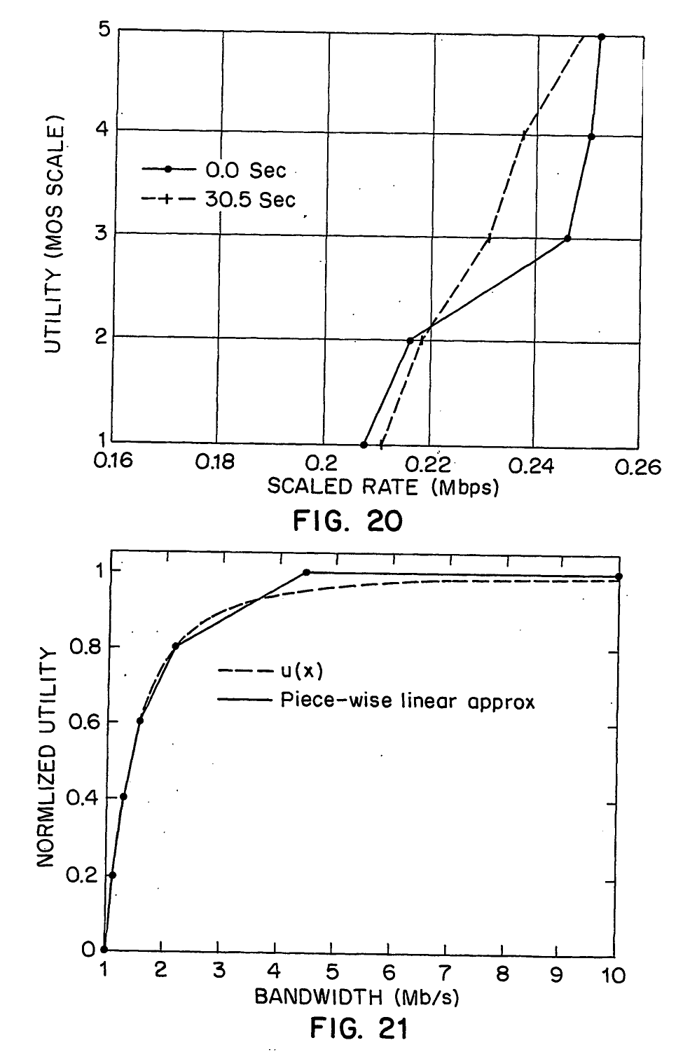

For audio/video applications using the well-known User Datagram Protocol (“UDP”)—which generally has no self-regulating rate control, no error correction, and no re-transmission mechanism—the bandwidth utility function is equivalent to the well-known distortion-rate function used in information theory. For such applications, the utility of a given bandwidth is the reverse of the amount of quality distortion under this bandwidth limit. Quality distortion can occur due to information loss at the encoder (e.g., for rate-controlled encoding) or inside the network (e.g., for media scaling). Since distortion-rate functions are usually dependent on the content and the characteristics of the encoder, a practical approach to utility generation for video/audio content is to measure the distortion associated with various amounts of scaled-down bandwidth. The distortion can be measured using subjective metrics such as the well-known 5-level mean-opinion score (MOS) test which can be used to construct a utility function “off-line” (i.e., before running a utility-aggregation or network control algorithm). Preferably, distortion is measured using objective metrics such as the Signal-to-Noise Ratio (SNR). The simplicity of the SNR approach facilitates on-line utility function generation. FIG. 20 illustrates exemplary utility functions generated for an MPEG-1 video trace using an on-line method. The curves are calculated based on the utility of the most valuable (i.e., highest-utility) interval of frames in a given set of intervals, assuming a given amount of available bandwidth. Each curve can be viewed as the “envelope” of the per-frame rate-distortion function for the previous generation interval. The per-frame rate-distortion function is obtained by a dynamic rate shaping mechanism which regulates the rate of MPEG traffic by dropping, from the MPEG frames, the particular data likely to cause, by their absence, the least amount of distortion for a given amount of available bandwidth.

In order to extend the aforementioned utility formation methods from the case of an individual application to the case of flow aggregates (i.e., groups of data flows), a method of utility aggregation should be chosen. There are generally two types of allocation policies: maximizing the sum of the utility (i.e., welfare-maximization) and fairness-based policies. A particularly advantageous fairness-based policy is a “proportional utility-fair” policy which allocates bandwidth to each flow (or flow aggregate) such that the scaled utility of each flow or aggregate, compared to the total utility, will be the same for all flows (or flow aggregates).

For TCP-like reliable transport protocols, the effect of packet drops generally does not cause information distortion, but it can cause loss of “goodput” (i.e., the rate of transmission of properly transported data) due to retransmissions and congestion-avoidance algorithms. Therefore, a distortion-based bandwidth utility function is not necessarily applicable to the TCP case. For TCP data, it can be preferable to determine the utility and/or a utility function based on the effect of the packet loss on TCP goodput. A normalized utility function for TCP can be defined as

$$U ( x ) = 1 - \frac{goodput}{throughout} \approx 1 - \frac{p x}{x} = 1 - p ,$$

where p is the packet loss rate. This approximation of utility valuation is based on the steady-state behavior of selective acknowledgement (“SACK”) TCP under the condition of light to moderate packet losses, which is a reasonable assumption for a core network with provisioning. SACK is a well-known format for sending information, from a TCP receiver to a TCP sender, regarding which TCP packets must be re-transmitted. For the aggregation of TCP flows experiencing approximately similar rates of packet loss, the normalized aggregated utility function is

$${U}_{agg\_TCP} ( x ) = 1 - \frac{\sum goodput}{\sum throughout} \approx \frac{p \sum x}{\sum x} = 1 - p ,$$

which is the same as the individual utility function. The value of p can be derived from a TCP steady-state throughput-loss formula given by the inequality

$$x < ( \frac{MSS}{RTT} ) \frac{1}{\sqrt{p}} ,$$

where MSS is the maximum segment size and RTT IS the round trip delay. If bₘᵢₙ is used to denote the minimum bandwidth for TCP flow (aggregate) with a non-zero utility valuation,

$${b}_{min} = n \frac{MSS}{RTT} ,$$

where n is the number of active flows in the aggregate. Then the upper bound on loss rate is:

$$p < \frac{{b}_{min}^{2}}{{x}^{2}} ,$$

and

$${U}_{agg\_TCP} ( x ) = 1 - \frac{{b}_{min}^{2}}{{x}^{2}} . \qquad ( 12 )$$

In the DiffServ service profile, bₘᵢₙ can be specified as part of the service plan, taking into consideration the service charge, the size of flow aggregate (n) and the average round trip delay (RTT). Furthermore, there can be two distinct types of utility function, one used to model TCP sessions sending data through only one core network, and another used to model TCP sessions sending data through two or more networks. The multi-network utility function can, for example, use a bₘᵢₙ having a value of one third of that of the single-network function, if a session typically passes data through three core networks whenever it passes data through more than one core network.

For simplicity, each utility function can be quantized into a piece-wise linear function having K utility levels. The kth segment of a piece-wise linear utility function U.(x) can be denoted as

U.(x)=η.,ₖ(x−b.,ₖ)+u.,ₖ, ∀xε[b.,ₖ,b.,ₖ₊₁) where η.,k≧0 (13)

is the slope, “.” denotes an index such as i or j, and the kth linear segment of U.(x) is denoted as

U.,ₖ(x)Δη.,ₖ(x−b.,ₖ)+u.,ₖ, ∀xε[b.,ₖ,b.,ₖ₊₁).

For TCP utility functions, because U(x)→1 only when x→∞, the maximum bandwidth can be approximated by setting it to a value corresponding to 95% of the maximum utility, i.e., b.,K=bₘᵢₙ/\sqrt{0.05}.

The piece-wise linear utility function can be denoted by a vector of its first-order discontinuity points such that:

$$⟨ ( \begin{matrix}{u}_{i} , 1 \\ {b}_{i} , 1\end{matrix} ) ⃛ ( \begin{matrix}{u}_{i} , {K}_{i} \\ {b}_{i} , {K}_{i}\end{matrix} ) ⟩ \qquad ( 14 )$$

and from Equation 12, it can be seen that the vector representation for TCP aggregated utility function is:

$$⟨ ( \begin{matrix}0 \\ {b}_{i , min}\end{matrix} ) ( \begin{matrix}0.2 \\ 1.12 {b}_{i , min}\end{matrix} ) ( \begin{matrix}0.4 \\ 1.29 {b}_{i , min}\end{matrix} ) ( \begin{matrix}0.6 \\ 1.58 {b}_{i , min}\end{matrix} ) ( \begin{matrix}0.8 \\ 2.24 {b}_{i , min}\end{matrix} ) ( \begin{matrix}1 \\ 4.47 {b}_{i , min}\end{matrix} ) ⟩ \qquad ( 15 )$$

FIG. 21 illustrates an example of bandwidth utility function and its corresponding piece-wise linear approximation for a TCP aggregate for which bₘᵢₙ=1 Mb/s.

For an individual non-adaptive application, the bandwidth utility function tends to have a convex-downward functional form having a slope which increases up to a maximum utility point at which the curve becomes flat—i.e., additional bandwidth is not useful. Such a form is typical of audio and/or video applications which require a small amount of bandwidth in comparison to the capacity of the link(s) carrying the data. For flows with such convex-downward utility functions, welfare-maximum allocation is equivalent to sequential allocation; that is, the allocation will satisfy one flow to its maximum utility before assigning available bandwidth to another flow. Therefore, if a flow aggregate contains essentially nothing but non-adaptive applications, each having a convex-downward bandwidth utility function, the aggregated bandwidth utility function under welfare-maximized conditions can be viewed as a “cascade” of individual convex utility functions. The cascade of individual utility functions can be generated by allocating bandwidth to a sequence of data categories (e.g., flows or applications), each member of the sequence receiving, the ideal case, the exact amount of bandwidth needed to reach its maximum utility point—any additional bandwidth allocated to the category would be wasted. When all of the total available bandwidth has been allocated, the remaining categories—i.e., the non-member categories—receive no bandwidth at all. The result is an allocation in which some categories receive the maximum amount of bandwidth they can use, some categories receive no bandwidth at all, and no more than one category—the last member of the sequence—receives an allocation which partially fulfills its requirements.

However, in order to achieve the maximum possible utility, it is preferable to properly select categories for membership in the sequence. Accordingly, the utility-maximizing procedure considers every possible combination of categories which can be selected for membership, and chooses the set of members which yields the greatest amount of utility. This selection procedure is performed for multiple values of total available bandwidth, in order to generate an aggregated bandwidth utility function. The aggregated bandwidth utility function can be approximated as a linear function having a slope of uₘₐₓ/bₘₐₓ between the two points (0,0) and (nbₘₐₓ, nuₘₐₓ), where n is the number of flows, bₘₐₓ is the maximum required bandwidth, and uₘₐₓ is the corresponding utility of each individual application. In other words,

$$\begin{matrix}{U}_{agg\_rigid} ( x ) = {U}_{single} ( x - ⌊ \frac{x}{{b}_{max}} ⌋ ) + ⌊ \frac{x}{{b}_{max}} ⌋ {u}_{max} \approx ( \frac{{u}_{max}}{{b}_{max}} ) x , \\ ∀ x ∈ [ 0 , n {b}_{max} ]\end{matrix} \qquad ( 16 )$$

In summary, the aggregation of bandwidth utility functions can be performed according to the following application categories:

TCP-based application aggregates: Equation 12 (for continuous utility functions) or Equation 15 (for “quantized”—i.e, piece-wise linear—utility functions) can be used;

“Small” UDP-based audio/video application aggregates, wherein each application consumes small bandwidth in comparison to the capacity of the link carrying the data: Equation 16 can be used; and

“Large” UDP-based audio/video application having large bandwidth consumption in comparison to link capacity: utility function is based on measured distortion rate.

Calculating an aggregated utility function can be more complex in the general case than in the above-described special case in which all of the individual utility functions are convex-downward. In the general case, each individual utility function can be approximated by a piece-wise linear function having a finite number of points. For each point in the aggregated curve, there is a particular amount of available bandwidth. The utility-maximizing algorithm can consider every possible combination of every point in all of the individual utility functions, where the combination uses the particular amount of available bandwidth. In other words, the algorithm can consider every possible combination of bandwidth allocations that completely utilizes all of the available bandwidth. The algorithm then selects the combination that yields the greatest amount of utility. As expressed mathematically, the welfare-maximizing allocation distributes the link capacity C into per-flow (aggregate) allocations x=(x₁, . . . , xₙ) to maximize Σₖ₌₁ⁿUₖ(xₖ) under the constraint that Σₖ₌₁ⁿxₖ=C, where xₖ≧20.

The maximization problem with target functions that are not always concave-downward is an NP-hard problem. In the case of convex-downward utility functions, the optimal solution lies at the extreme points of the convex hull, as determined by enumerating through all the extreme points. However, the complexity of the aggregation procedure can be reduced by exploiting the structure of piece-wise linear utility functions and by reducing the algorithm's search space. In particular, the determination of how bandwidth is to be allocated to maximize utility can be performed in two or more stages. At the first stage, an intermediate utility function is calculated for a set of two or more “first-level” data categories, each category having its own utility function. The two or more first-level categories are thus combined into a second-level category having its own utility function. A similar procedure can be performed at this stage for any number of sets of categories, thereby generating utility functions for a number of aggregated, second-level categories. A second stage of aggregation can then be performed by allocating bandwidth among two or more second-level categories, thereby generating either a final utility function result or a number of aggregated, third-level utility functions. In fact, any number of levels of aggregation can thus be employed, ultimately resulting in a final, aggregated utility function.

In accordance with a particularly advantageous aspect of the present invention, the size of the search space—i.e., the number of combinations of allocations that are considered by the algorithm—can be reduced by defining upper and lower limits on the slope of a portion of an intermediate aggregated utility function. The algorithm refrains from considering any combination of bandwidth allocation that would result in a slope outside the defined range. In other words, when calculating an intermediate utility function as discussed above, the algorithm stops generating any additional points in one or both directions once the upper or lower slope limit is reached. The increased efficiency of this approach can be demonstrated as follows.

A direct result from the well-known Kuhn-Tucker condition which is necessary for maximization (see H. W. Kuhn and A. W. Tucker, “Non-linear Programming”, In Proc. 2^{nd} Berkeley Symp. on Mathematical Statistics and Probability, pp. 481-492.) is that, at the maximum-utility allocation

$$( {x}_{1}^{*} , … , {x}_{n}^{*} ) ,$$

the allocation to i belongs to one of the two sets: either i

$$i ∈ D {=}^{Δ} \{ j / {U}_{j}^{′} ( {x}_{j}^{*} - ) \neq {U}_{j}^{′} ( {x}_{j}^{*} + ) \} ,$$

namely x*ᵢ is at a first-order discontinuity point of Uᵢ(x); or otherwise, ∀i,jε\overline{D},Uᵢ(x*ᵢ) and Uⱼ(x*ⱼ) have the same slope: U′ᵢ(x*ᵢ)=U′(x*ⱼ). In addition, the slope has to meet the condition that

U′ⱼ(x*ⱼ−)≧U′ᵢ(x*ᵢ)≧U′ⱼ(x*ⱼ₊), ∀iε\overline{D} and jεD (17)

For i,jε\overline{D}, the individual functions can be expected to have the same slope, because otherwise, total utility could be increased by shifting bandwidth from a function with a lower slope to one with a higher slope. By the same argument, the slope of Uᵢ(x*ᵢ),iεD can be expected to be no greater than the slope of Uⱼ(x*ⱼ−), and no smaller than that of Uⱼ(x*ⱼ+), for jεD.

When aggregating two piece-wise linear utility functions Uᵢ(x) and Uⱼ(x), the aggregated utility function is composed from the set of shifted linear segments of Uᵢ(x) and Uⱼ(x), which can be represented by {U_{i,l}(x−b_{j,m})+u_{j,m}, U_{j,m}(x−b_{i,l})+u_{i,l}} with l=0, 1, . . . , K(i), and m=0, 1, . . . , K(j). Based on Inequality (17), we can remove at least one of U_{i,l}(x−b_{j,m})+U_{j,m} and U_{j,m}(x−b_{i,l})+u_{i,l} from the set because they can not both satisfy the inequality. In addition, when Uᵢ(x) is convex, all U_{j,m}(x−b_{i,l})+u_{i,l} except l=0, or K(i) will be removed. This will significantly reduce the operating space needed to perform the aggregation.

An additional way to allocate resources is to use a “utility-fair” algorithm. Categories receive selected amounts of bandwidth such that they all achieve the same utility value. A particularly advantageous technique is a “proportional utility-fair” algorithm. Instead of giving all categories the same absolute utility value, such as in a simple, utility-fair procedure, a proportional utility-fair procedure assigns a weighted utility value to each data category.

The normalized discrete utility levels of a piece-wise linear function uᵢ(x) can be denoted as a set

$$\{ \frac{{u}_{i , k ( i )}}{{u}_{i}^{max}} \} .$$

The aggregated utility function u_{agg}(x) can be considered an aggregated set which is the union of each individual set

$${⋃}_{i} \{ \frac{{u}_{i , k ( i )}}{{u}_{i}^{max}} \} .$$

The members of the aggregated set can be renamed and sorted in ascending order as ψₖ.

Under this policy, the aggregated utility function becomes:

$$\begin{matrix}{U}_{agg} ( x ) = \frac{( {ψ}_{k + 1} - {ψ}_{k} ) {u}_{agg}^{max}}{{b}_{agg , k + 1} - {b}_{agg , k}} ( x - {b}_{agg , k} ) + {ψ}_{k} {u}_{agg}^{max} , \\ ∀ x ∈ [ {b}_{agg , k} , {b}_{agg , k + 1} ) ,\end{matrix} \qquad ( 18 )$$

$$where {u}_{agg}^{max} = {\sum }_{i} {u}_{i}^{max} , and {b}_{agg , k} = {\sum }_{i} {U}_{i}^{- 1} ( {ψ}_{k} {u}_{i}^{max} ) .$$

Given a link capacity C, the resulting allocation xᵢ and utility value uᵢ to each flow (aggregate) is:

$${u}_{i} = \frac{{U}_{agg} ( c )}{{u}_{agg}^{max}} {u}_{i}^{max} , and {x}_{i} = {U}_{i}^{- 1} ( {u}_{i} ) . \qquad ( 19 )$$

The aggregated utility function under a proportional utility-fair allocation contains information about the bandwidth associated with each individual utility function. If a utility function is removed from the aggregated utility function, the reverse operation of Equation 18 does not affect other individual utility functions.

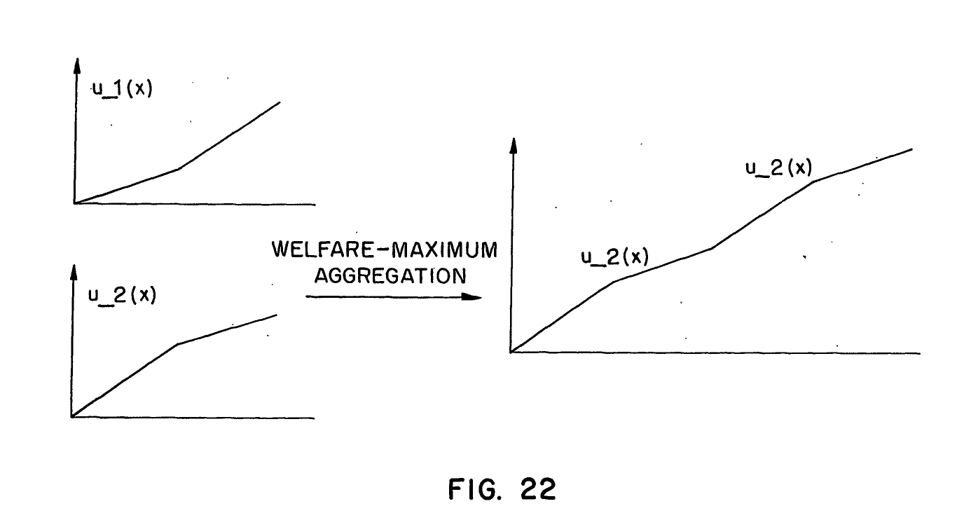

However, this is not the case for the welfare-maximum policy. As shown in FIG. 22, u₁(x) is convex and u₂(x) is concave. The aggregation of these two functions only contains information of the concave function u₂(x). When u₂(x) is removed from the aggregated utility function, there is insufficient information to reconstruct u₁(x). In this sense the utility function state is not scalable under welfare-maximum allocation. Because of this reason and complexity, welfare-maximum allocation is preferably not used for large numbers of flows (aggregates) with convex utility.

The dynamic provisioning algorithms in the core network—e.g., the above-described node-provisioning algorithm—tend to react to persistent network congestion. This naturally leads to time-varying rate allocation at the edges of the network. This can pose a significant challenge for link sharing if the capacity of the link is time-varying. When the link capacity is time-varying, the distribution policy should preferably dynamically adjust the bandwidth allocation for individual flows. Accordingly, quantitative distribution rules based on bandwidth utility functions can be useful to dynamically guide the distribution of bandwidth.

In accordance with the present invention, a U(x)-CBQ traffic conditioner can be used to regulate users' traffic which shares the same network service class at an ingress link to a core network. The CBQ link sharing structure comprises two levels of policy-driven weight allocations. At the upper level, each CBQ agency (i.e., customer) corresponds to one DiffServ service profile subscriber. The ‘link sharing weights’ are allocated by a proportional utility-fair policy to enforce fairness among users subscribing to the same service plan. Because each aggregated utility function is truncated to bₘₐₓ, users subscribing to different plans (i e., plans having different values of bₘₐₓ) will also be handled in a proportional utility-fair manner.

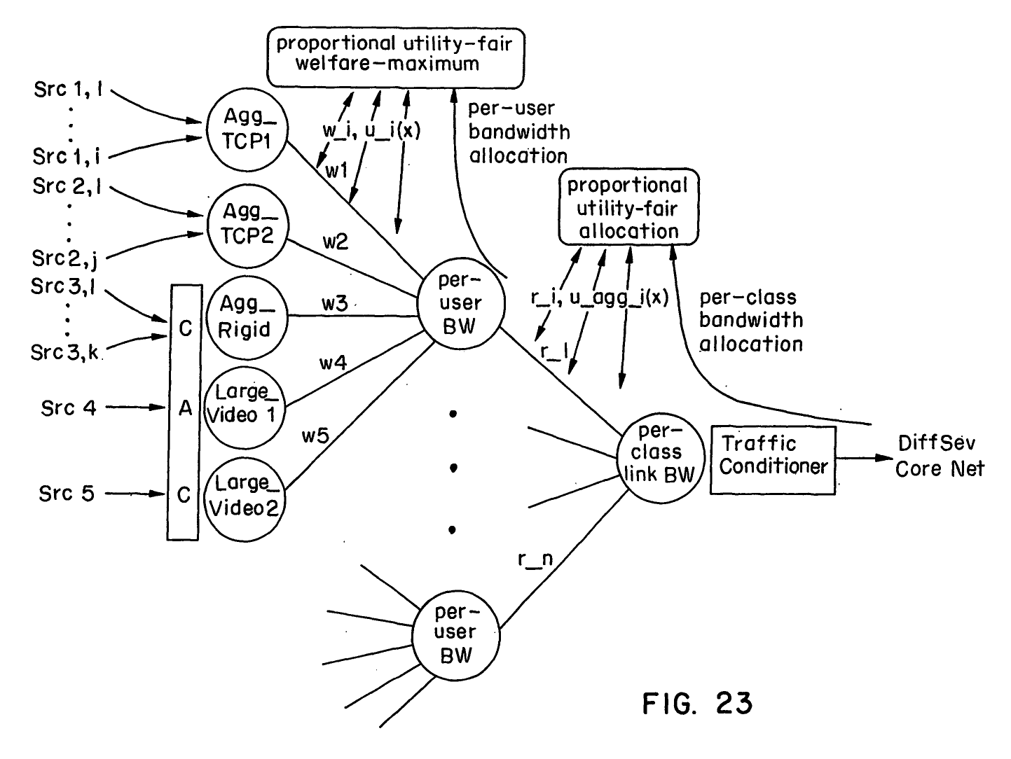

At the lower level, within the data set of each customer, sharing classes are categorized by application type with respect to the utility function characteristics associated with each application type. FIG. 23 illustrates the aggregation of, and allocation of bandwidth to, data categories associated with the three application types discussed above, namely TCP aggregates, aggregates of a large number of small-size non-adaptive applications, and individual large-size adaptive video applications. The TCP aggregates can be further classified into categories for intra- and inter-core networks, respectively.

Commonly used CBQ formal link-sharing guidelines can employed. The well-known weighted round robin (WRR) algorithm can be used as the scheduler for CBQ because the service weight of each class provides a clean interface to the utility-based allocation algorithms of the present invention.

CBQ was originally designed to support packet scheduling rather than traffic shaping/policing. When CBQ is used as a traffic policer instead of traffic shaper, the scheduling buffer is preferably reduced or removed. In some cases, it can be desirable to use small buffer size (e.g., 1-2 packets) for every leaf class in order to facilitate proper operation of the CBQ WRR scheduler. Optionally, the same priority can be used for all the leaf classes of a CBQ agency, because priority in traffic shaping/policing does not reduce traffic burstiness. In CBQ, the link sharing weights control the proportion of bandwidth allocated to each class. Therefore administering sharing weights is equivalent to allocating bandwidth.

In accordance with the invention, a hybrid allocation policy can be used to determine CBQ sharing weights. The policy represents a hybrid constructed from a proportional utility-fair policy and a welfare-maximizing policy. The hybrid allocation policy can be beneficial because of the distinctly different behavior of adaptive and non-adaptive applications.

At the highest level, a proportional utility-fair policy is used to administer sharing weights based on each user's service profile and monthly charge. At the lowest level (i.e., utility aggregation level), adaptive applications with homogenous concave utility functions (e.g., TCP) are aggregated under a proportional utility-fair policy. In this case, proportional utility-fair and welfare-maximum are equivalent. In the case of non-adaptive applications with convex utility functions, the categories need only be aggregated under the welfare-maximum policy. Otherwise, a bandwidth reduction can significantly reduce the utility of all the individual flows due to the convex-downward nature of the individual utility functions. For this reason, an admission control (CAC) module can be used, as illustrated in FIG. 23. The role of admission control is to safeguard the minimum bandwidth needs of individual video flows that have large bandwidth requirements, as well as the bandwidth needs of non-adaptive applications at the ingress link. These measures help to avoid the random dropping/marking, by traffic conditioners, of data in non-adaptive traffic aggregates, which can affect all the individual flows within an aggregate. The impact of such dropping/marking can be limited to a few individual flows, thereby maintaining the welfare-maximum allocation using measurement-based admission control.

At the middle level, it is possible to use either one of the allocation policies to distribute sharing weights among different flows (aggregates) for the same user. Mixing policy in this manner causes no conflict due of the link sharing hierarchy. One policy is not necessarily better than the other in all cases. The welfare-maximizing policy has clear economic meaning, and can provide incentive compatibility for applications to cooperate. When bandwidth changes occur, the welfare-maximizing policy tends to adjust the allocation to only one flow, rather than all the flows, as would occur under proportional utility-fair allocation. The choice of policy for the middle level can be made by the user and the service profile provider.

Algorithms in accordance with the present invention have been evaluated using an ns simulator with built-in CBQ and DiffServ modules. The simulated topology is a simplified version of the one shown in FIG. 23; that is, one access link shared by two agencies. The access link has DiffServ AF1 class bandwidth varying over time. The maximum link capacity is set to 10 Mb/s. Each agency represents one user profile. Agency A has a maximum bandwidth quota b_{A,max}=8 Mb/s, which is twice as much as b_{B,max}=4 Mb/s. This does not necessarily translate into a doubled bandwidth allocation for user A, because the exact allocation depends on the shape of the aggregated utility function. This is beneficial feature of utility-based allocation, which is capable of realizing complex application-dependent and capacity-dependent allocation rules.

The leaf classes for agency A are Agg_TCP1, Agg_TCP2, and Large_Video1, and the leaf classes for agency B are Agg_TCP1 and Large_Video2. The admission control module and the Agg_Rigid leaf class are not explicitly simulated in the example, because their effect on bandwidth reservation can be incorporated into the bₘᵢₙ value of the other aggregated classes.

A single constant-bit-rate source for each leaf class is used, where each has a peak rate higher than the link capacity. The packet size is set to 1000 bytes for TCP aggregates and 500 bytes for video flows.

The formula from Equation 4 is used to set the utility function for Agg_TCP1 and Agg_TCP2, where bₘᵢₙ for Agg_TCP1 and Agg_TCP2 is chosen as 0.8 Mb/s and 0.27 Mb/s, respectively, to reflect a 100 ms and 300 ms RTT in intra-core and inter-core cases. In both cases, the number of active flows in each aggregate is chosen to be 10 and MSS is 8 Kb. The maximum utility value uₘₐₓ is specified. For agent A, uₘₐₓ is set to be 4 for Agg_TCP1 and Agg_TCP2, and for agent B, uₘₐₓ=2, so that agency A has a higher grade service profile than agency B both in terms of b.,ₘₐₓ and uₘₐₓ. The two utility functions for Large_Video1 and Large_Video2 are measured from the MPEG1 video trace discussed above.

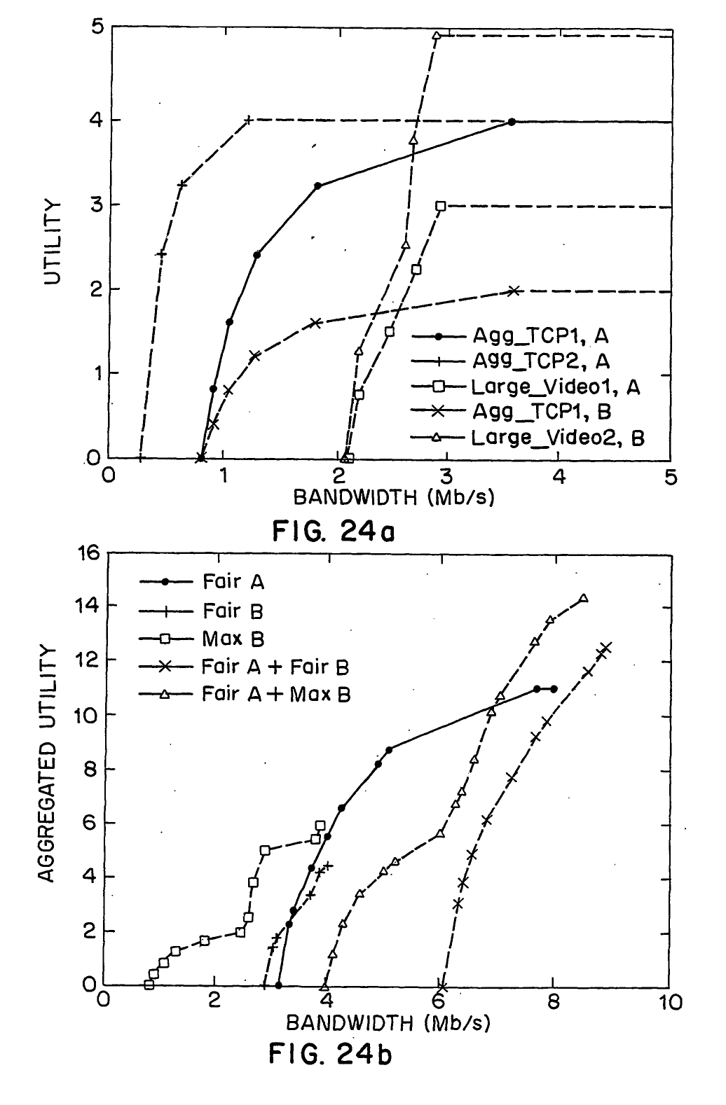

FIGS. 24a and 24b illustrate all the utility functions used in the simulation. FIG. 24a illustrates the individual utility functions, while FIG. 24b illustrates the aggregate utility functions under the proportional utility-fair policy for agency A and B, under the welfare-maximization policy for B, and under the proportional utility-fair policy at the top level. The results demonstrate that the proportional utility-fair and welfare-maximum formulae of the invention can be applied to complex aggregation operations of piece-wise linear utility functions with different discrete utility levels, uₘₐₓ, bₘᵢₙ and bₘₐₓ.

Two additional scenarios have also been simulated. In the first scenario, proportional utility-fair policy is used at all link sharing levels. In the second scenario, welfare-maximum policy is adopted for agency B only. The assigned link capacity to this service class starts from 90% of the link capacity and then reduces to 80% and 70% at 20 and 35 seconds, respectively, before finally increasing to 100% of the link physical capacity. This sequence of changes invokes the dynamic link sharing algorithms to adjust the link sharing ratio for individual classes.

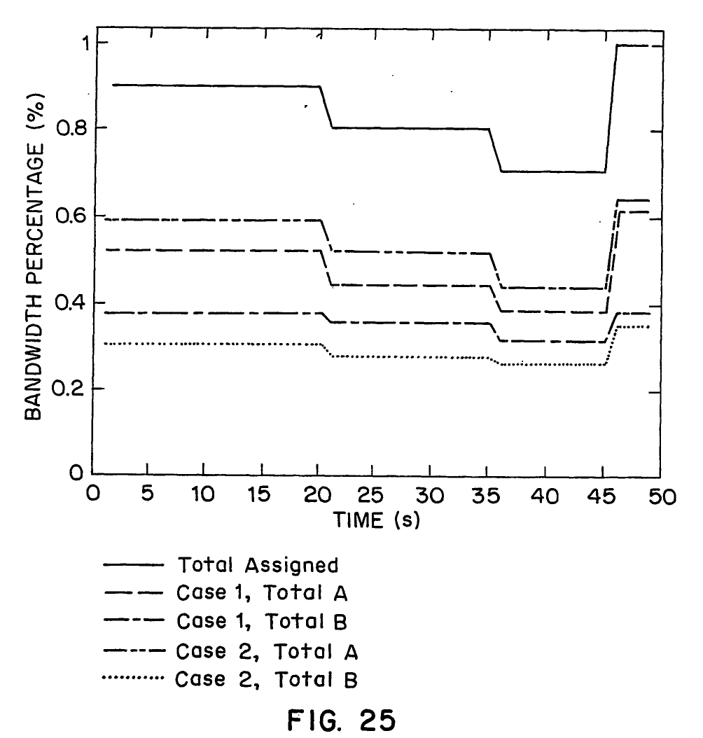

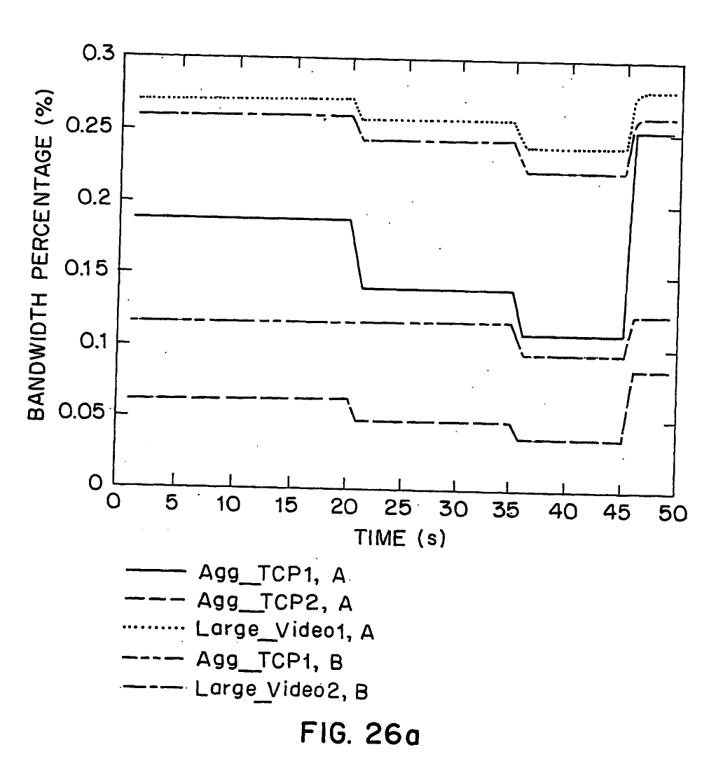

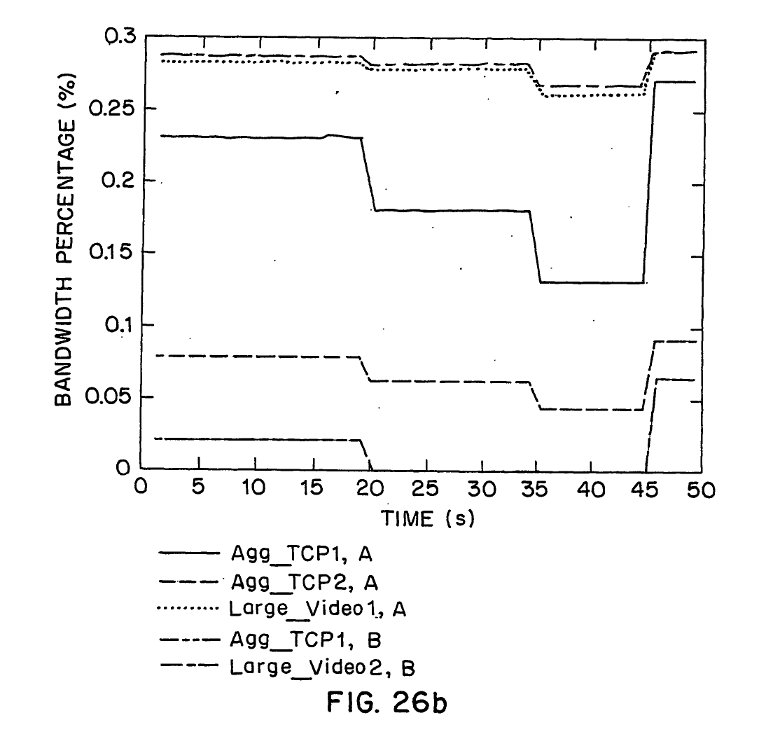

The simulation results are shown in FIGS. 25, 26a, and 26b. The three plots represent traces of throughput measurement for each flow (aggregate). Bandwidth values are presented as relative values of the ingress link capacity.

FIG. 25 demonstrates the link sharing effect with time-varying link capacity. It can be seen that the hybrid link-sharing policies do not cause any policy conflict. The difference between the aggregated allocation under the first and second scenarios are a result of the different shape of aggregated utility functions for agency B, as illustrated in FIG. 24b, where one set up data is aggregated under the proportional utility-fair policy and the other set under the welfare-maximization policy. Other than this difference, the top level link sharing treats both scenarios equally.

The benefits of the bandwidth utility function generation techniques of the present invention can be further appreciated by studying the effectiveness of controlling b_{A,max} and b_{B,max} Since b_{B,max} is limited to 4 Mb/s, the two aggregated utility functions of agency B are truncated at 4 Mb/s as shown in FIG. 24b. This equally limits the allocation of agency B below 4 Mb/s, which is verified by the bottom two traces in FIG. 25.

A steep rise in agency A's allocation occurs when the available bandwidth is increased from 7 to 10 Mb/s. The reason for this is that agency B's aggregated utility function rises sharply towards the maximum bandwidth, while agency A's aggregated utility function is relatively flat as shown in FIG. 24b. Under conditions where there is an increase in the available bandwidth, agency A will take a much larger proportion of the increased bandwidth with the same proportion of utility increase.

FIGS. 26a and 26b illustrate lower-tier link sharing results within the leaf classes of agency A and B, respectively. Both figures illustrate the effect of using uₘₐₓ to differentiate bandwidth allocation. As shown in FIG. 24a, within agency B, a large uₘₐₓ=5 is chosen for the Large_Video2 flow while at the same time a small uₘₐₓ=3 is chosen for the Agg_TCP1 flow aggregate. The differentiation in bandwidth allocation is visible for the first scenario of proportional utility-fair policy, primarily from the large bₘᵢₙ of the Large_Video2 flow. However, this allocation differentiation is significantly increased in the second scenario of welfare-maximum allocation. In fact, Agg_TCP 1 is consistently starved, as is shown at the bottom of FIG. 26b, while the allocation curve of Large_Video2 appears at the top of the plot.

The above-described simulations demonstrate the effectiveness of the U(x)-CBQ algorithm of the present invention and identify several control parameters that can be adjusted to offer differentiated service. These include the maximum subscribed bandwidth at the agency level, the maximum utility value of a bandwidth utility function, the minimum and maximum bandwidth of a utility function, and the bandwidth utility function itself.

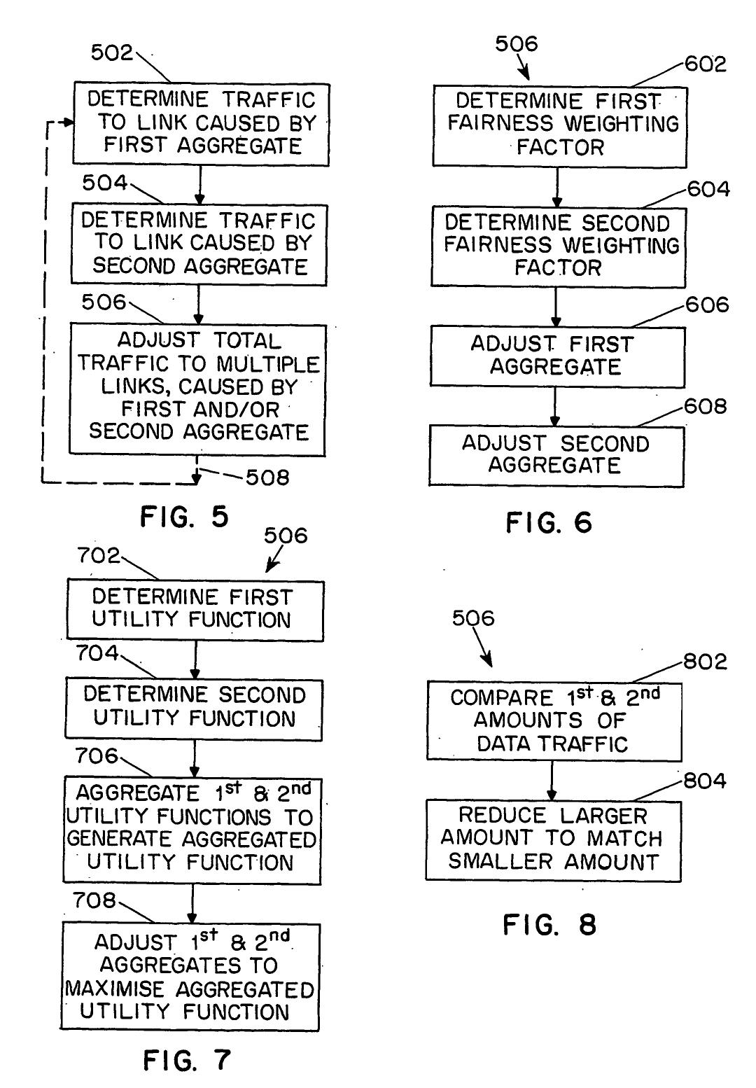

FIG. 5 illustrates an exemplary procedure for allocating network resources in accordance with the invention. The procedure of FIG. 5 can be used to adjust the amount traffic carried by a network link. The link can be associated with an ingress or an egress, or can be a link in the core of the network. Each link carries traffic from one or more aggregates. Each aggregate can originate from a particular ingress or other source, or can be associated with a particular category (based on, e.g., class or user) of data. In the case of the procedure of FIG. 5, a single link carries traffic associated with at least two aggregates. The traffic in the link caused by each of the aggregates is measured (steps 502 and 504). In addition, each of the two aggregates includes data which do not flow to the particular link being monitored in this example, but may flow to other links in the network. The total traffic of each aggregate, which includes traffic flowing to the link being regulated, as well as traffic which does not flow to the link being regulated, is adjusted (step 506). The adjustment can be done in such a way as to achieve fairness (e.g., proportional utility-based fairness) between the two aggregates, or to maximize the aggregated utility of the two aggregates. In addition, the adjustment can be made based upon a branch-penalty-minimization procedure, which is discussed in detail above. Optionally, the procedure of FIG. 5 can be performed once, or can be looped back (step 508) to repeat the procedure two or more times.

A particular embodiment of step 506 of FIG. 5 is illustrated in FIG. 6. The procedure of FIG. 6 utilizes fairness criteria to adjust the amount of data being transmitted in the first and second aggregates. First, a fairness weighting factor is determined for each aggregate (steps 602 and 604). Each aggregate is adjusted in accordance with its weighting factor (steps 606 and 608). As discussed above, the amounts of data in the two aggregates can be adjusted in such a way as to insure that the weighted utilities of the aggregates are approximately equal. The utility functions can be based on Equations (18) and (19) above.

FIG. 7 illustrates an additional embodiment of step 506 of FIG. 5. The procedure illustrated in FIG. 7 seeks to maximize an aggregated utility function of the two aggregates. First, the utility functions of the first and second aggregates are determined (steps 702 and 704). The two utility functions are aggregated to generate an aggregated utility function (step 706). The amounts of data in the two aggregates are then adjusted so as to maximize the aggregated utility function (step 708).

FIG. 8 illustrates yet another embodiment of step 506 of FIG. 5. In the procedure of FIG. 8, the respective amounts of data traffic in two aggregates are compared (step 802). The larger of the two amounts is than reduced until it matches the smaller amount (step 804).

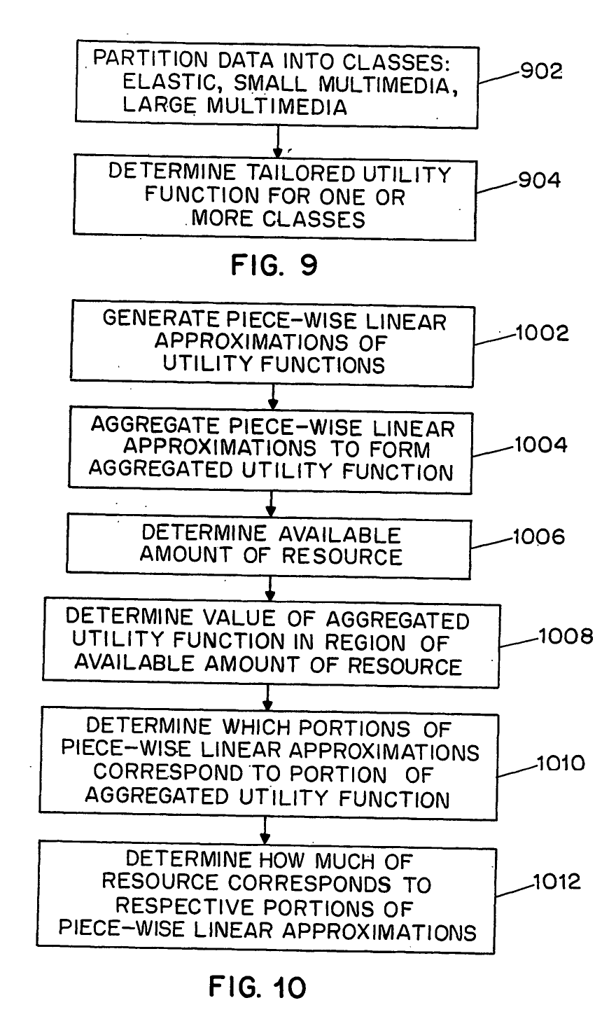

FIG. 9 illustrates an exemplary procedure for determining a utility function in accordance with the invention. In this procedure, data is partitioned into one or more classes (step 902). The classes can include an elastic class which comprises applications having utility functions which tend to be elastic with respect to the amount of a resource allocated to the data. In addition, the classes can include a small multimedia class and a large multimedia class. The large and small multimedia classes can be defined according to a threshold of resource usage—i.e., small multimedia applications are defined as those which tend to use fewer resources, and large multimedia applications are defined as those which tend to use more resources. For one or more of the aforementioned classes, the form (e.g. shape of a utility function is determined (step 904). The utility function form is tailored to the particular class. As discussed above, applications which transmit data in a TCP format tend to be relatively elastic. A utility function corresponding to TCP data can be based upon the microscopic throughput loss behavior of the protocol. For TCP-based applications, the utility functions are preferably piece-wise linear utility functions as described above with respect to Equations (13)-(15). For small audio/video applications, Equation (16) is preferably used. For large audio/video applications, measured distortion is preferably used.

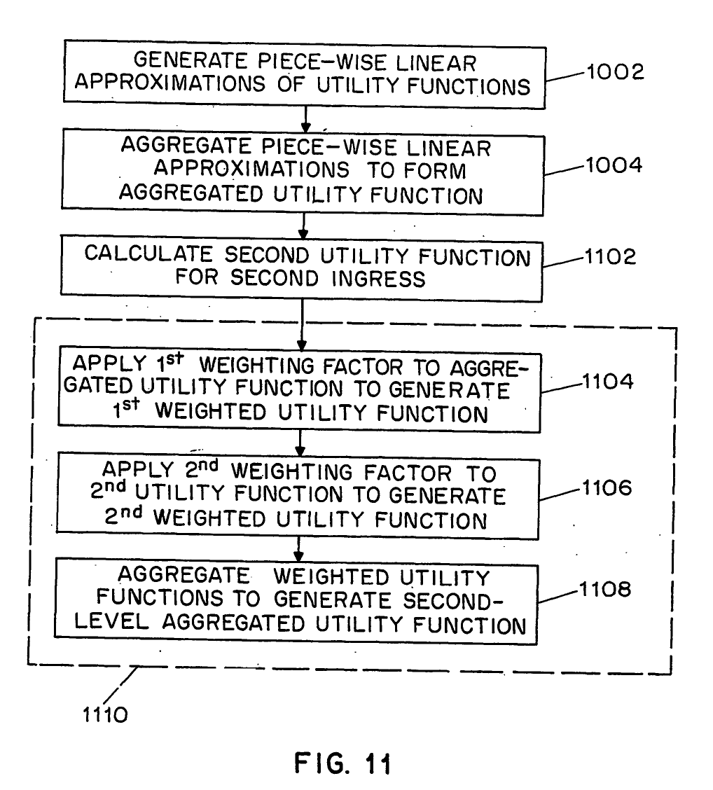

FIG. 10 illustrates an additional method of determining a utility function in accordance with the present invention. In the procedure of FIG. 10, a plurality of utility functions are modeled using piece-wise linear utility functions (step 1002). The piece-wise linear approximations are aggregated to form an aggregated utility function (step 1004). The aggregated utility function can itself be a piece-wise linear function representing an upper envelope constructed by determining an upper bound of the set of piece-wise linear utility functions, wherein a point representing an amount of resource and a corresponding amount of utility is selected from each of the individual utility functions. As discussed in detail above, each point of the upper envelope function can be determined by selecting a combination of points from the individual utility functions, such that the selected combination utilizes all of the available amount of a resource in a way that produces the maximum amount of utility.

In the procedure illustrated in FIG. 10, the available amount of the resource is determined (step 1006). The algorithm determines the utility value associated with at least one point of a portion of the aggregated utility function in the region of the available amount of the resource (step 1008). Based upon the aforementioned utility value of the aggregated utility function, it is then possible to determine which portions of the piece-wise linear approximations correspond to that portion of the aggregated utility function (step 1010). The determination of the respective portions of the piece-wise linear approximations enables a determination of the amount of the resource which corresponds to each of respective portions of the piece-wise linear approximations (step 1012). The total utility of the data can than be maximized by allocating the aforementioned amounts of the resource to the respective categories of data to which the piece-wise linear approximations correspond.

The technique of aggregating a plurality of piece-wise linear utility functions can also be used as part of a procedure which includes multiple levels of aggregation. Such a procedure is illustrated in FIG. 11. In the procedure of FIG. 11, piece-wise linear approximations of utility functions are generated for multiple sets of data being transmitted between a first ingress and a selected egress (step 1002). The piece-wise linear approximations are aggregated to form an aggregated utility function which is itself associated with the transmission of data between the first ingress and the selected egress (step 1004). A second utility function is calculated for data transmitted between a second ingress and the selected egress (step 1102). The aggregated utility function associated with the first ingress is than aggregated with the second utility function to generate a second-level aggregated utility function (step 1110). Optionally, the second level aggregation step 1110 of FIG. 11 can be configured to achieve proportional fairness between the first set of data—which travels between the first ingress and the selected egress—and the second set of data—which travels between the second ingress and the selected egress. For example, a first weighting factor can be applied to the utility function of the data originating at the first ingress, in order to generate a first weighted utility function (step 1104). A second weighing factor can be applied to the utility function of the data originating from the second ingress, in order to generate a second weighted utility function (step 1106). The weighted utility functions can than be aggregated to generate the second-level aggregated utility function (step 1108).

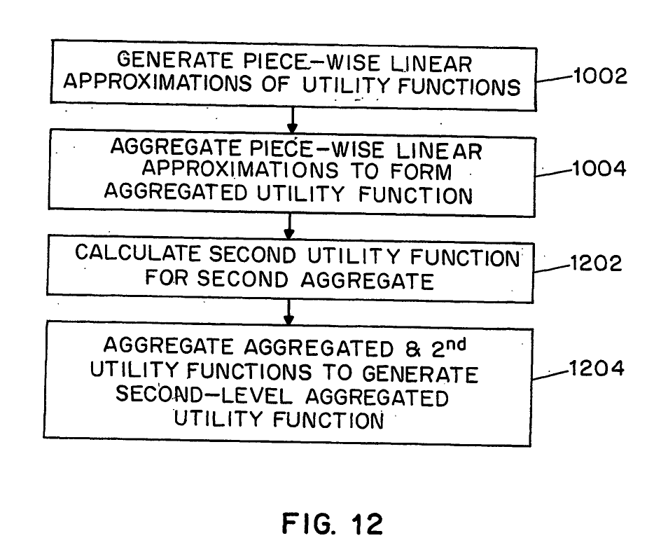

FIG. 12 illustrates an exemplary procedure for aggregating utility functions associated with more than one aggregate. First, piece-wise linear approximations of utility functions of two or more data sets are generated (step 1002). The piece-wise linear approximations are aggregated to form an aggregated utility function which is associated with a first data aggregate (step 1004). A second utility function is calculated for a second aggregate (step 1202). Then, the utility functions of the first and second aggregates are themselves aggregated to generate a second-level aggregated utility function (step 1204).

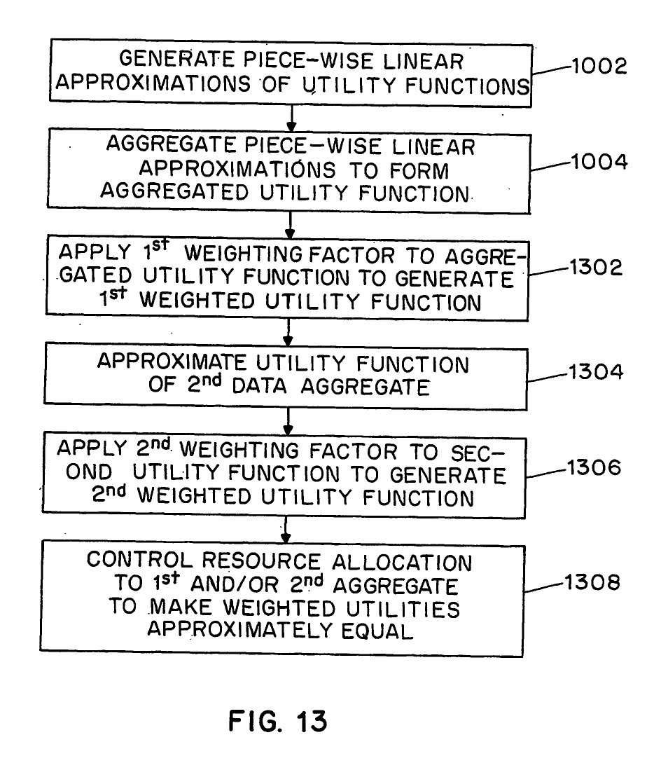

FIG. 13 illustrates an example of a procedure for determining a utility function, in which fairness-based criteria are used to allocate resources among two or more data aggregates. An aggregated utility function of a first aggregate is generated by generating piece-wise linear approximations of a plurality of individual functions (step 1002) and aggregating the piece-wise linear functions to form an aggregated utility function (step 1004). A first weighting factor is applied to the aggregated utility function in order to generate a first weighted utility function (step 1302). An approximate utility function is calculated for a second data aggregate (step 1304). A second weighting factor is applied to the utility function of the second data aggregate, in order to generate a second weighted utility function (step 1306). Resource allocation to the first and/or second aggregate is controlled such as to make the weighted utilities of the first and second aggregates approximately equal (step 1308).

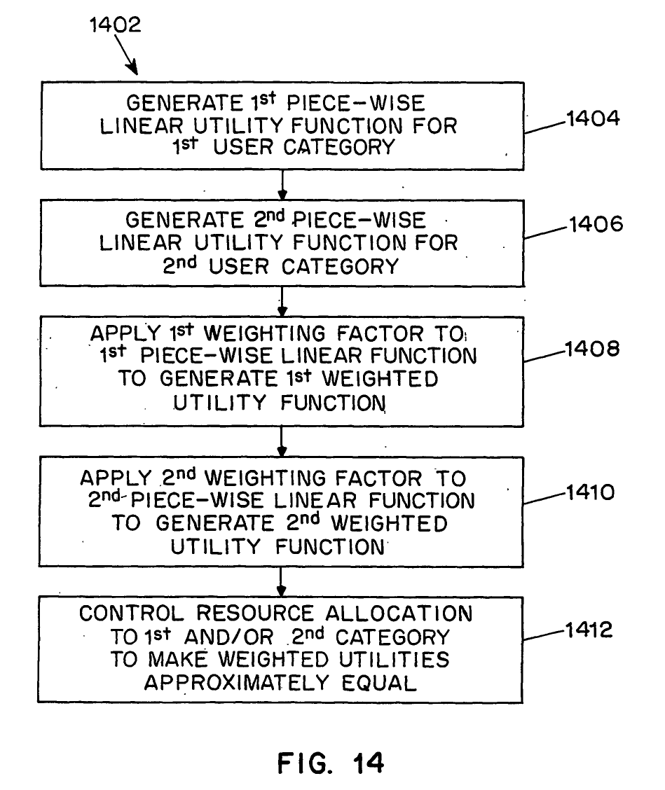

FIG. 14 illustrates an exemplary procedure for allocating resources among two or more resource user categories in accordance with the present invention. A piece-wise linear utility function is generated for each category (steps 1404 and 1406). A weighting factor is applied to each of the piece-wise linear utility functions to generate a weighted utility function for each user category (steps 1408 and 1410). The allocation of resources to each category is controlled to make the weighted utilities associated with the categories approximately equal (step 1412).

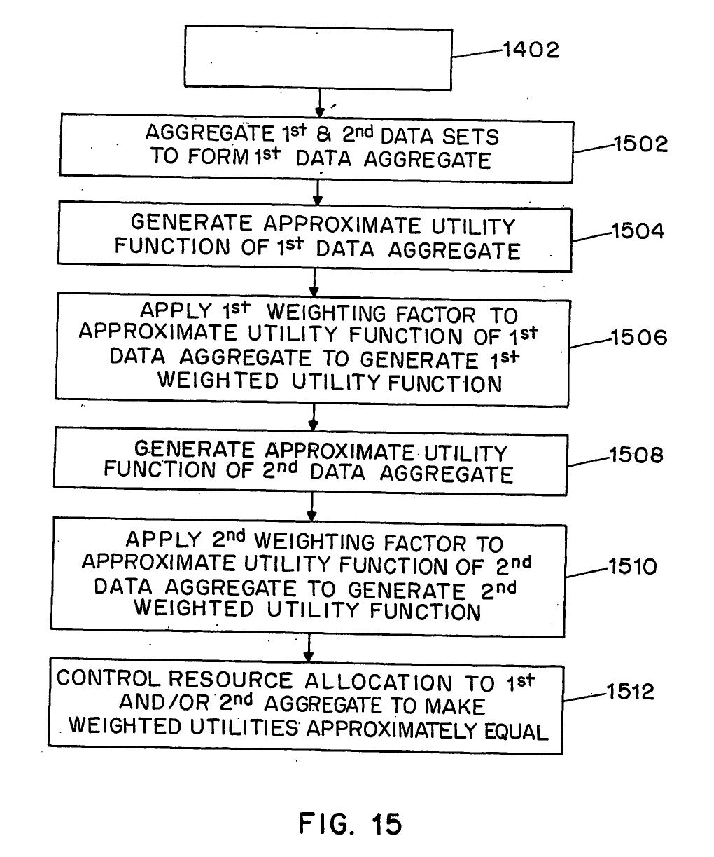

In addition, the data in two or more resource user categories can be aggregated to form a data aggregate. This data aggregate can, in turn, be aggregated with one or more other data aggregates to form a second-level data aggregate. An exemplary procedure for allocating resources among two or more data aggregates is illustrated in FIG. 15. Step 1402 of FIG. 15 represents steps 1404, 1406, 1408, 1410, and 1412 of FIG. 14 in combination. The first and second data sets associated with the first and second user categories, respectively, of FIG. 14 are aggregated to form a first data aggregate (step 1502). An approximate utility function is generated for the first data aggregate (1504). A first weighting factor is applied to the approximate utility function of the first data aggregate to generate a first weighted utility function (step 1506). An approximate utility function of a second data aggregate is generated (step 1508). A second weighting factor is applied to the approximate utility function of the second data aggregate to generate a second weighted utility function (step 1510). The amount of a network resource allocated to the first and/or second data aggregate is controlled so as to make the weighted utilities of the aggregates approximately equal (step 1512).

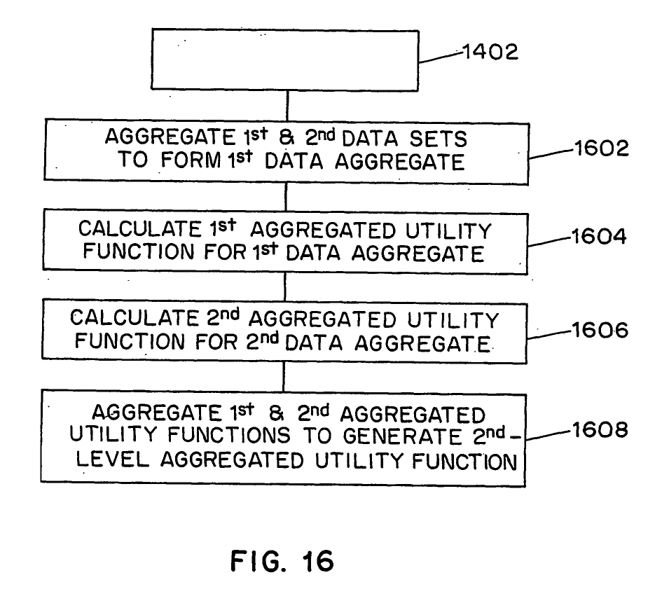

FIG. 16 illustrates an additional example of a multi-level procedure for aggregating data sets. Similarly to the procedure of FIG. 15, step 1402 of FIG. 16 represents steps 1404, 1406, 1408, 1410, and 1412 of FIG. 14 in combination. The procedure of FIG. 16 aggregates first and second data sets associated with the first and second resource user categories, respectively, of the procedure of FIG. 14, in order to form a first data aggregate (step 1602). An aggregated utility function is calculated for the first data aggregate (step 1604). An additional aggregated utility function is calculated for a second data aggregate (step 1606). The aggregated utility function of the first and second data aggregates are themselves aggregated in order to generate a second-level aggregated utility function (step 1608).

A network in accordance with the present invention can also include one or more egresses (e.g., egresses 1812 of FIG. 18) which communicate data to one or more adjacent networks (a/k/a “adjacent domains” or “adjacent autonomous systems”). At each egress, for each type of data (e.g., for each class), a particular amount of bandwidth is purchased and/or negotiated from the “down stream” network (i.e., the network receiving the data). The traffic load matrix, which is stored in the load matrix storage device 1804 of FIG. 18, can communicate information to an egress regarding the ingress from which a particular data packet has originated.

If one of the egresses 1812 is congested, this congestion is communicated to the dynamic core provisioning algorithm 1806 which reduces the amount of traffic entering at all ingresses 1810 feeding data to the congested egress. As a result, there is likely to be unused bandwidth at the other egresses, because the traffic in the network is likely to be reduced below the level that would lead to congestion in the other egresses. Therefore, it can be desirable in some cases to reduce the amount of bandwidth purchased and/or negotiated for the non-congested egresses. Alternatively, if additional throughput is desired, it can be beneficial to purchase and/or negotiate additional bandwidth for a congested egress. It can be particularly advantageous to allocate the purchase and/or negotiation of bandwidth to the various egresses in such a way as to cause all of the egresses to be equally congested, or operate with an equal likelihood of congestion.

In some cases, the desired allocation of bandwidth to the various egresses can be achieved by increasing the amount of bandwidth purchased and/or negotiated for egresses which tend to be more congested, and decreasing the amount of bandwidth purchased and/or negotiated for egresses which tend to be less congested. In order to better understand the interdependence of egress capacity and ingress capacity, consider a core network with a set LΔ{1, 2, . . . , L} of link identifiers of per-class unidirectional links. Let cₗ be the finite capacity of link l,lεL. Similarly, let the set KΔ{1, 2, . . . , K} denote the set of per-class nodes in a core network, and specifically, the set of per-class edge nodes is denoted as ε,ε⊂K.

A core network traffic load is represented by a matrix A={a_{l,i}} that models the per DiffServ user traffic distribution on links lεL, where a_{l,i} indicates the fraction of traffic from user i passing through link l. Let the link load vector be c and user traffic vector be u. Then:

c=Au. (20)

Without loss of generality, the columns of A can be rearranged into J sub-matrices, one for each class. Then: A=[A(1) [symbol] A(2) [symbol] . . . [symbol] A(J)] and u=[u(1) [symbol] u(2) [symbol] . . . [symbol] u(J)]^{T}.

The construction of matrix A is based on the measurement of its column vectors a.,ⱼ, each representing the traffic distribution of one user i. There are a number of commonly used methods for constructing the matrix A from distributed traffic measurements. For example, a direct method counts the number of packets flowing through a network interface card that connects to a particular link. In this method, the packets in each flow category are counted. The data can be categorized using packet header information such as IP addresses or sources and/or destinations, port numbers, and/or protocol numbers. The classification field of a packet can also be used. The direct method tends to be quite accurate, but can slow down routers. Therefore, this method is typically reserved for use at the edges of the network.

An indirect method can also be used to measure traffic through one or more links. The indirect method infers the amount of a particular category of data flowing through a particular link —typically an interior link—by using direct measurements at the network ingresses, coupled with information about network topology and routing. Topology information can be obtained from the network management system. Routing information can be obtained from the network routing table and the routing configuration files.

For this calculation, it is assumed that the matrix is updated in a timely manner. The interdependence of egress and ingress link capacity provisioning can also be modeled by using the traffic load matrix A. The rows of c and A can be rearranged so that

$$c = [ \begin{matrix}{c}_{core} \\ … \\ {c}_{out}\end{matrix} ] .$$

which represents the capacity of internal links of the core network and the egress links, respectively, and

$$A = [ \begin{matrix}{A}_{core} \\ … \\ {A}_{out}\end{matrix} ] .$$

The relationship between ingress link and egress link capacity then becomes:

cₒᵤₜ=Aₒᵤₜu. (21)

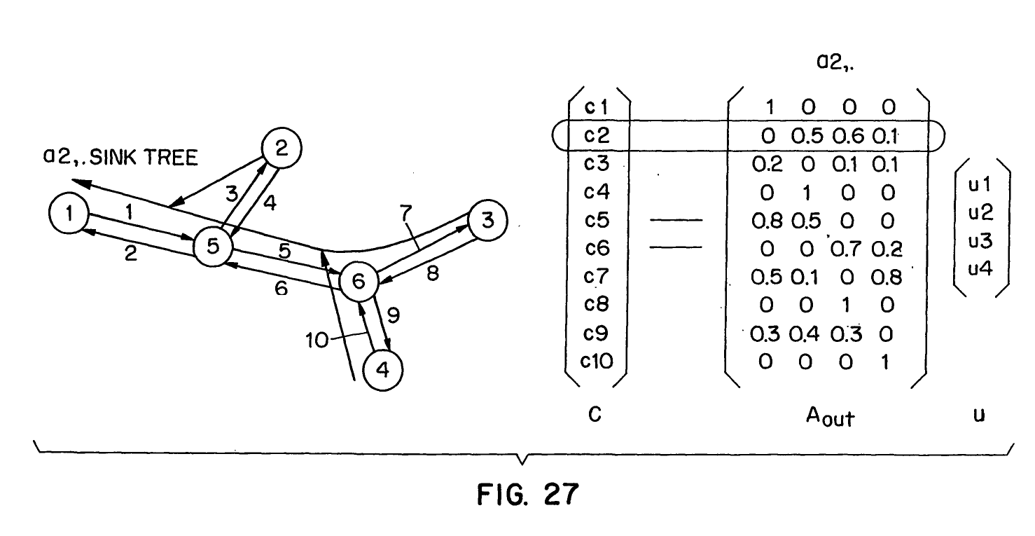

FIG. 27 illustrates an example of the relationship between egress and ingress link capacity. Each row of the matrix Aₒᵤₜ, i.e., a_{i,}. represents a sink-tree rooted at egress link cᵢ. The leaf nodes of the sink-tree represented ingress user traffic aggregates {uⱼ|a_{i,j}>0}, which contributes traffic to egress link capacity cᵢ.

The capacity negotiation of multiple egress links can be coordinated using dynamic programming. The partition of c=Au into cₒᵤₜ=Aₒᵤₜu and c_{core}=A_{core}u forms the basis for dynamic programming. First, the ideal egress link capacity is calculated by assuming that all the egress links are not bottlenecks. Using the traffic load matrix, the resulting optimal bandwidth allocation at ingress links can provide effective capacity dimensioning at the egress links.

Assuming that cₒᵤₜ=∞ in c=Au, the matrix equation constraint becomes equivalent to c_{core}=A_{core}u. Then under the constraint of A_{core}u<c_{core}, with a modified max-min fair allocation, the optimal ingress bandwidth allocation û(n) is obtained. The algorithm is modified from the standard max-min fair algorithm. The detection of the most congested link is changed to take into consideration the tree structure of a Diff Serv traffic aggregate rather than a single pipe. This operation provides one sample of the ideal egress link capacity: ĉₒᵤₜ(n)=Aₒᵤₜû(n).

The actual capacity vector ĉₒᵤₜ used for capacity negotiation is obtained as a probabilistic upper-bound on {ĉₒᵤₜ(n)} for control robustness. The bound can be obtained by using the techniques employed in measurement based admission control (e.g., the Chemoff bound).

Using the same approach, egress bandwidth utility functions can be constructed for use at the ingress traffic conditioners of peering networks. The utility function Uᵢ(x) at egress link i is calculated by aggregating all the ingress aggregated utility functions {Uⱼ(x)|a_{i,j}>0} under the proportional utility fair formula of Equation (18). In addition, each Uⱼ(x) is scaled in bandwidth by a multiplicative factor a_{i,j} because only the a_{i,j} portion of ingress j traffic passes through egress link i. Because of the property of proportional utility-fair allocation, the egress-aggregated utility function will have uᵢ^{max}=Σ_{j:a}_{_{i,j}}₀uⱼ^{max}. This property of aggregated utility value is equal to the sum of individual utility value is important in DiffServ because traffic conditioning in DiffServ is for flow aggregates. The bandwidth decrease at any one egress link will cause the corresponding ingress links to throttle back even though only a small portion of traffic may be flowing through the congested egress link.

The same technique can be used to obtain a probabilistic bound Ûᵢ(x) on the samples of {Uᵢ(x,n)}. Such algorithms have been described in the literature. Because proportional utility-fair allocation is used, the probabilistic bound is a lower-bound on utility which translates into an upper-bound on allocated bandwidth.

With ĉₒᵤₜ, egress links can negotiate with peering/transit networks with or without market based techniques (e.g., auctions). When the peer network supports a U(x)-CBQ traffic conditioner, Ûᵢ(x) enables the creation of a scalable bandwidth provisioning architecture. The egress link i can become a regular subscriber to its peering network by submitting the utility function Ûᵢ(x) to the U(x)-CBQ traffic conditioner. A peer network need not treat its network peers in any special manner, because the aggregated utility function will reflect the importance of a network peer via uₘₐₓ and bₘᵢₙ.

The outcome from bandwidth negotiation/bidding is a vector of allocated egress bandwidth c*ₒᵤₜ<ĉₒᵤₜ. Since inconsistency can occur in this distributed allocation operation, to avoid bandwidth waste, a coordinated relaxation operation is used to calculate the accepted bandwidth \tilde{c}ₒᵤₜ based on the assigned bandwidth c*ₒᵤₜ. One approach is proportional reduction:

$${\tilde{c}}_{out} = γ {\hat{c}}_{out} , where γ = {min}_{i} \{ \frac{{c}_{i}^{*}}{{\hat{c}}_{i}} \} . \qquad ( 22 )$$

However, when a core network has multiple bottleneck links, proportional reduction can be over-conservative. Therefore, it can be advantageous to put c*ₒᵤₜ in c=Au to calculate ũ by a modified max-min fair algorithm. Subsequently, \tilde{c}ₒᵤₜ=Aₒᵤₜũ.

Because egress capacity dimensioning interacts with peer/transit networks in addition to its local core network, it is expected that egress capacity dimensioning will operate over slower time scales than ingress capacity provisioning in order to improve algorithm robustness to local perturbations.

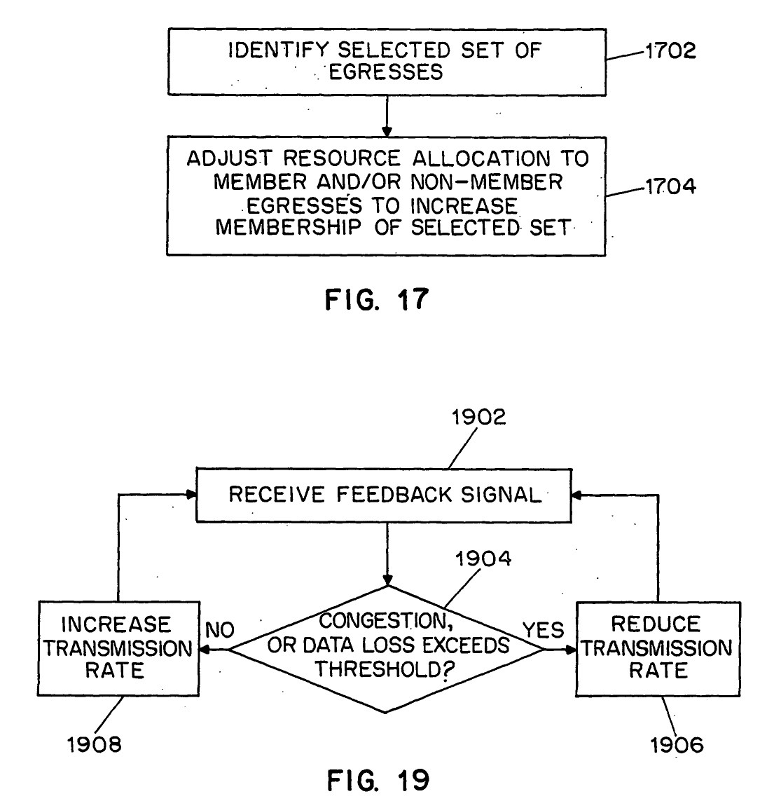

FIG. 17 illustrates an exemplary procedure for adjusting resource allocation to network egresses in accordance with the present invention. A fairness-based algorithm is used to identity a set of member egresses having a particular amount of congestability—i.e., susceptibly to congestion (step 1702). The fairness-based algorithm can optionally assign a utility function to each egress, and the utility functions can optionally be weighted utility functions. The egresses belonging to the selected set all have approximately the same amount of congestability. However, the congestabilities used for this determination can be weighted. Egresses not belonging to the selected set have congestabilities unequal to the congestabilities of the member egresses. The allocation of resources to the member egresses and/or at least one non-member egress is adjusted so as to bring an increased number of egresses within the membership criteria of the selected set (step 1704). For example, if the member egresses have a higher congestability than all of the other egresses in the network, it can be desirable to increase the bandwidth allocated to all of the member egresses until the congestability of the member egresses matches that of the next-most-congested egress. Alternatively, if the selected set of member egresses is less congested than at least one non-member egress, it may be desirable to increase the bandwidth allocated to the non-member egress so as to qualify the non-member egress for membership in the selected set.

In some cases, it can be desirable to reduce expenditures on bandwidth. In such cases, if the member egresses are the most congestable egresses in the network, it can be beneficial to reduce the amount of bandwidth allocated to other egresses in the network so as to qualify the other egresses for membership in the selected set. If, for example, the member egresses are the least congestable egresses in the network, and it is desirable to reduce expenditures on bandwidth, the amount of bandwidth purchased and/or negotiated for the member egresses can be reduced until the congestability of the member egresses matches that of the next least congestable egress. Furthermore, the set of member egresses may comprise neither the most congestable nor the least congestable egresses in the network. Depending upon the importance of reducing expenditures on bandwidth, and the importance of increasing the amount of available bandwidth, the allocation of bandwidth to less-congestable egresses can generally be reduced, the allocation of bandwidth to more-congestable ingresses can be increased, and the amount of bandwidth allocated to the member egresses can be either increased or decreased. Ideally, it is desirable to adjust the respective bandwidth amounts until all egresses are members of the selected set.

In addition, it can be desirable to adjust the allocations of bandwidth in such a way as to minimize the variance of the adjustment amounts, the sum of the adjustment amounts, and/or the sum of the absolute values of the adjustment amounts.

It will be appreciated by those skilled in the art that the exemplary methods illustrated by FIGS. 1-27 can be implemented on various standard computer platforms and/or routing systems operating under the control of suitable software. In particular, core provisioning algorithms in accordance with the present invention can be implemented on a server computer. Utility function calculation and aggregation algorithms in accordance with the present invention can be implemented within a standard ingress module or router module. Ingress provisioning algorithms in accordance with the present invention can also be implemented within a standard ingress module or router module. Egress dimensioning algorithms in accordance with the present invention can be implemented in a standard egress module or routing module. In some cases, dedicated computer hardware, such as a peripheral card which resides on the bus of a standard personal computer, may enhance the operational efficiency of the above methods.

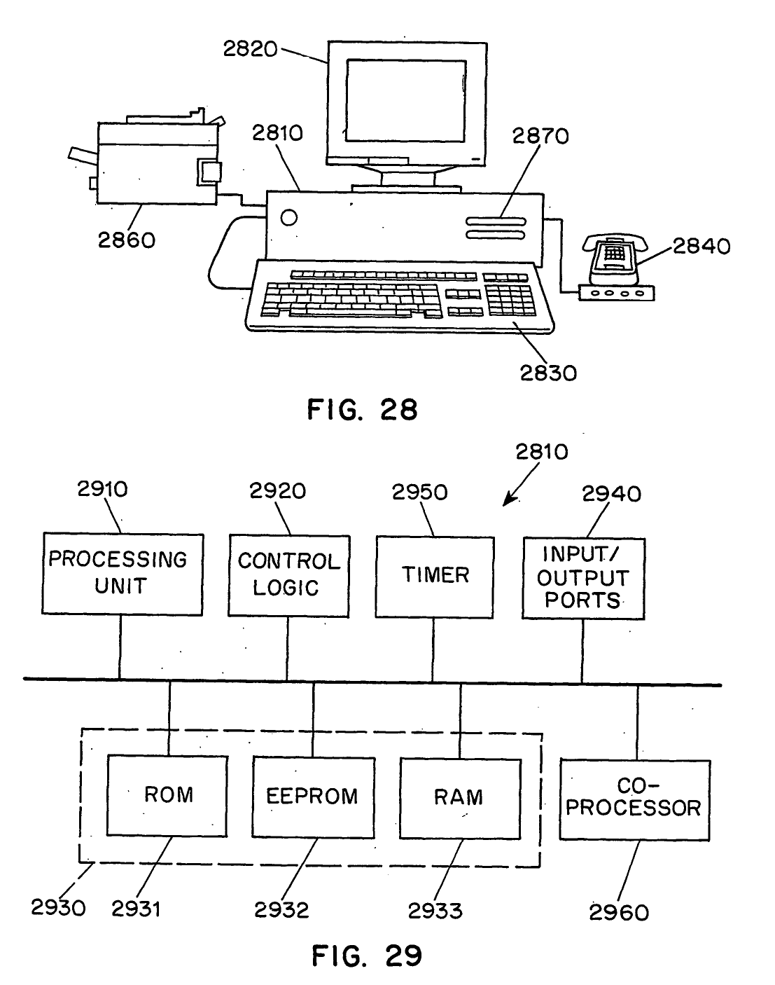

FIGS. 28 and 29 illustrate typical computer hardware suitable for practicing the present invention. Referring to FIG. 28, the computer system includes a computer section 2810, a display 2820, a keyboard 2830, and a communications peripheral device 2840, such as a modem. The system can also include a printer 2860. The computer system generally includes one or more disk drives 2870 which can read and write to computer readable media, such as magnetic media (i.e., diskettes) or optical media (i.e., CD-ROMS) for storing data and application software. While not shown, other input devices, such as a digital pointer (e.g., a “mouse”) and the like may also be included.

FIG. 29 is a functional block diagram which further illustrates the computer section 2810. The computer section 2810 generally includes a processing unit 2910, control logic 2920 and a memory unit 2930. Preferably, computer section 2810 can also include a timer 2950 and input/output ports 2940. The computer section 2810 can also include a co-processor 2960, depending on the microprocessor used in the processing unit. Control logic 2920 provides, in conjunction with processing unit 2910, the control necessary to handle communications between memory unit 2930 and input/output ports 2940. Timer 2950 provides a timing reference signal for processing unit 2910 and control logic 2920. Co-processor 2960 provides an enhanced ability to perform complex computations in real time, such as those required by cryptographic algorithms.

Memory unit 2930 may include different types of memory, such as volatile and non-volatile memory and read-only and programmable memory. For example, as shown in FIG. 29, memory unit 2930 may include read-only memory (ROM) 2931, electrically erasable programmable read-only memory (EEPROM) 2932, and random-access memory (RAM) 2935. Different computer processors, memory configurations, data structures and the like can be used to practice the present invention, and the invention is not limited to a specific platform.

Referring to FIG. 2, is to be noted that a routing module 202, an ingress module 204, or an egress module 206 can also include the processing unit 2910, control logic 2920, timer 2950, ports 2940, memory unit 2930, and co-processor 2960 illustrated in FIG. 29. The aforementioned components enable the routing module 202, ingress module 204, or egress module 206 to run software in accordance with the present invention.

Although the present invention has been described in connection with specific exemplary embodiments, it should be understood that various changes, substitutions and alterations can be made to the disclosed embodiments without departing from the spirit and scope of the invention as set forth in the appended claims.

What is claimed is:

1. A method of allocating network resources, comprising the steps of:
measuring at least one network parameter related to at least one of an amount of network resource usage, an amount of network traffic, and a service quality parameter;
applying a formula to the at least one network parameter to thereby generate a calculation result, the formula being associated with at least one of a Markovian process and a Poisson process; and
using the calculation result to dynamically adjust an allocation of at least one of the network resources.

2. A method according to claim 1, wherein the at least one network parameter comprises at least one of a queue size and a packet loss rate.

3. A method according to claim 1, wherein the step of using the calculation result comprises adjusting at least one service weight associated with at least one of a class, a user, a data source, and a data destination.

4. A method according to claim 1, wherein the calculation result comprises at least one probability of overuse of the at least one of the network resources.

5. A method according to claim 4, wherein the at least one of the network resources comprises at least one of a memory and a bandwidth capacity.

6. A method according to claim 1, further comprising communicating a plurality of status signals to a central controller, wherein the status signals are separated by at least one time period, and wherein the status signals convey information about the at least one network parameter.

7. A method according to claim 1, further comprising calculating a probability of violation of at least one service goal.

8. A method according to claim 1, further comprising using the calculation result to calculate a probability of overuse of the at least one of the network resources.

9. A method according to claim 8, wherein the step of using the calculation result comprises communicating a warning signal to a central controller if the probability of overuse equals or exceeds a probability threshold.

10. A method according to claim 1, wherein the at least one network parameter comprises a rate of change of network traffic.

11. A method according to claim 10, further comprising adjusting the allocation if the rate change of network traffic equals or exceeds a traffic change rate threshold.

12. A method according to claim 1, wherein the measuring step comprises:
measuring, at a first time at which the at least one of the network resources is not overloaded, a queue size and a packet loss rate;
measuring, at a second time at which the at least one of the network resources is overloaded, at least one of a packet arrival rate and a packet departure rate; and
applying a first mathematical operation to the queue size, the packet loss rate, and the at least one of the packet arrival rate and the packet departure rate, thereby generating a first congestability parameter related to an actual susceptibility to congestion of the at least one of the network resources, wherein the step of applying the formula comprises:
applying the formula to the at least one network parameter to thereby approximate a second congestability parameter related to an ideal susceptibility to congestion of the at least one of the network resources;
applying a second mathematical operation to the first and second congestability parameters, thereby generating at least one of a congestability difference and a congestability ratio; and
using the at least one of the congestability difference and the congestability ratio to determine a calculated amount of adjustment of the allocation of the at least one of the network resources, wherein the calculation result comprises the calculated amount of adjustment of the allocation, and wherein the step of using the calculation result comprises dynamically adjusting the allocation by an amount approximately equal to the calculated amount of adjustment.

13. A method of allocating network resources, comprising the steps of:
determining a first amount of data traffic flowing to a first network link, the first amount being associated with a first traffic aggregate;
determining a second amount of data traffic flowing to the first network link, the second amount being associated with a second traffic aggregate; and
using at least one adjustment rule to adjust at least one of a first aggregate amount and a second aggregate amount, the first aggregate amount comprising the first amount of data traffic and a third amount of data traffic associated with the first traffic aggregate and not flowing through the first network link, the second aggregate amount comprising the second amount of data traffic and a fourth amount of data traffic associated with the second traffic aggregate and not flowing through the first network link, and the at least one adjustment rule being based on at least one of fairness, a branch penalty, and maximization of an aggregated utility.

14. A method according to claim 13, wherein the at least one adjustment rule is based on a branch penalty.

15. A method according to claim 13, wherein the step of using the at least one adjustment rule comprises:
determining a first fairness weighting factor of the first traffic aggregate;
determining a second fairness weighting factor of the second traffic aggregate, the second fairness weighting factor being unequal to the first fairness weighting factor;
adjusting the first aggregate amount in accordance with the first fairness weighting factor; and
adjusting the second aggregate amount in accordance with the second fairness weighting factor.

16. A method according to claim 13, wherein the step of using the at least one adjustment rule comprises:
determining a first utility function of the first traffic aggregate;
determining a second utility function of the second traffic aggregate;
aggregating the first and second utility functions, thereby generating an aggregated utility function;
adjusting the first aggregate amount and the second aggregate amount, thereby maximizing the aggregated utility function.

17. A method according to claim 13, wherein the step of using the at least one adjustment rule comprises:
comparing the first and second amounts of data traffic to each other, thereby selecting a larger amount and a smaller amount;
reducing the larger amount, thereby rendering the larger amount not significantly larger than the smaller amount.

18. A method according to claim 13, wherein the step of using the at least one adjustment rule comprises minimizing a sum of first and second object functions, the first object function being associated with a fairness rule, and the second object function being associated with a branch penalty rule.

19. A method according to claim 18, wherein the step of minimizing the sum comprises calculating a Penrose-Moore matrix inverse of a matrix comprising a plurality of traffic amounts, wherein each of the plurality of traffic amounts is associated with at least one of a plurality of users.

20. A method according to claim 13, wherein the step of using the at least one adjustment rule comprises minimizing at least one of a variance of a plurality of adjustment amounts, a sum of the plurality of adjustment amounts, and a sum of absolute values of the plurality of adjustment amounts, the plurality of adjustment amounts comprising an amount by which the first aggregate amount is adjusted and an amount by which the second aggregate amount is adjusted.

21. A method of determining a utility function, comprising the steps of:
partitioning at least one data set into at least one of an elastic class comprising a plurality of applications and having a heightened utility elasticity, a small multimedia class, and a large multimedia class, wherein the small and large multimedia classes are defined according to at least one resource usage threshold; and
determining at least one form of at least one utility function, the form being tailored to the at least one of the elastic class, the small multimedia class, and at least one application within the large multimedia class.

22. A method according to claim 21, wherein the elastic class is transmitted using a transmission protocol in which a data sender performs an iterative loop, the iterative loop comprising the steps of:
receiving a feedback signal indicative of at least one of a congestion amount and a data loss rate;
reducing a data transmission rate if the at least one of the congestion amount and the data loss rate is greater than a threshold value; and
increasing the data transmission rate if the at least one of the congestion amount and the data loss rate is less than the threshold value.

23. A method according to claim 22, wherein the at least one form of the at least one utility function comprises an elastic class form tailored to the elastic class, the elastic class form being derived based upon macroscopic throughput loss behavior of the elastic class.

24. A method of determining a utility function, comprising the steps of:
approximating a plurality of utility functions using a plurality of piece-wise linear utility functions; and
aggregating the plurality of piece-wise linear utility functions to thereby form an aggregated utility function comprising an upper envelope function derived from the plurality of piece-wise linear utility functions, the upper envelope function comprising a plurality of linear segments, each of the plurality of linear segments having a slope having upper and lower limits.

25. A method according to claim 24, wherein the aggregated utility function comprises a function of at least one resource, the method further comprising:
determining an available amount of the at least one resource;
determining at least one utility value of a portion of the aggregated utility function, the portion of the aggregated utility function being associated with the available amount of the at least one resource;
using the at least one utility value of the portion of the aggregated utility function to select at least one portion of at least one of the plurality of piece-wise linear utility functions, the at least one portion being associated with the portion of the aggregated utility function;
using the at least one portion to determine an amount of the at least one resource to be allocated to at least one data category.

26. A method according to claim 25, wherein the at least one resource comprises a data communication network resource, wherein each of the plurality of utility functions is associated with one of a plurality of service classes, and wherein the at least one data category comprises the plurality of service classes.

27. A method according to claim 24, wherein the aggregated utility function is associated with data transmitted between a first ingress and a selected egress, the method further comprising:
calculating a second utility function associated with data transmitted between a second ingress and the selected egress; and
aggregating the aggregated utility function and the second utility function, thereby generating a second-level aggregated utility function.

28. A method according to claim 27, wherein the step of aggregating the aggregated utility function and the second utility function comprises:
applying a first weighting factor to the aggregated utility function, thereby generating a first weighted utility function;
applying a second weighting factor to the second utility function, thereby generating a second weighted utility function; and
aggregating the first and second weighted utility functions, thereby generating the second-level aggregated utility function.

29. A method according to claim 24, wherein the aggregated utility function is associated with a first data aggregate, the method further comprising:
calculating a second utility function associated with a second data aggregate; and
aggregating the aggregated utility function and the second utility function, thereby generating a second-level aggregated utility function.

30. A method according to claim 24, wherein the aggregated utility function is associated with a first data aggregate, the method further comprising:
weighting the aggregated utility function using a first weighting factor, thereby generating a first weighted utility function, the first weighted utility function representing a dependence of a weighted utility of the first data aggregate upon a first amount of a data communication network resource, the first amount of the data communication network resource being allocated to the first data aggregate;
approximating a utility function of a second data aggregate;
weighting the utility function of the second data aggregate using a second weighting factor, thereby generating a second weighted utility function, the second weighted utility function representing a dependence of a weighted utility of the second data aggregate upon a second amount of the data communication network resource, the second amount of the data communication network resource being allocated to the second data aggregate; and
controlling at least one of the first and second amounts of the data communication network resource, thereby causing the weighted utility of the first data aggregate to be approximately equal to the weighted utility of the second data aggregate.

31. A method according to claim 24, wherein the step of aggregating the plurality of piece-wise linear utility functions comprises weighting each of the plurality of piece-wise linear utility functions using one of a plurality of weighting factors, wherein at least two of the plurality of weighting factors are unequal.

32. A method according to claim 24, wherein each of the plurality of utility functions comprises a function of a data communication network resource.

33. A method of allocating resources, comprising the steps of:
approximating a first utility function using a first piece-wise linear utility function, wherein the first utility function is associated with a first resource user category;
approximating a second utility function using a second piece-wise linear utility function, wherein the second utility function is associated with a second resource user category;
weighting the first piece-wise linear utility function using a first weighting factor, thereby generating a first weighted utility function, the first weighted utility function representing a dependence of a weighted utility associated with the first resource user category upon a first amount of at least one resource, the first amount of the at least one resource being allocated to the first resource user category;
weighting the second piece-wise linear utility function using a second weighting factor unequal to the first weighting factor, thereby generating a second weighted utility function, the second weighted utility function representing a dependence of a weighted utility associated with the second resource user category upon a second amount of the at least one resource, the second amount of the at least one resource being allocated to the second resource user category; and
controlling at least one of the first and second amounts of the at least one resource such that the weighted utility associated with the first resource user category is approximately equal to the weighted utility associated with the second resource user category.

34. A method according to claim 33, wherein the first resource user category defines a first data set, wherein the second resource user category defines a second data set, and wherein the at least one resource comprises a data communication network resource, the method further comprising:
aggregating the first and second data sets, thereby forming a first data aggregate;
generating an approximate utility function of the first data aggregate;
weighting the approximate utility function of the first data aggregate using a first weighting factor, thereby generating a first weighted utility function, the first weighted utility function representing a dependence of a weighted utility of the first data aggregate upon a first amount of the data communication network resource, the first amount of the data communication network resource being allocated to the first data aggregate;
generating an approximate a utility function of a second data aggregate;
weighting the approximate utility function of the second data aggregate using a second weighting factor, thereby generating a second weighted utility function, the second weighted utility function representing a dependence of a weighted utility of the second data aggregate upon a second amount of the data communication network resource, the second amount of the data communication network resource being allocated to the second data aggregate; and
controlling at least one of the first and second amounts of the data communication network resource, thereby causing the weighted utility of the first data aggregate to be approximately equal to the weighted utility of the second data aggregate.

35. A method according to claim 33, wherein the first resource user category defines a first data set, wherein the second resource user category defines a second data set, and wherein the at least one resource comprises a data communication network resource, the method further comprising:
aggregating the first and second data sets, thereby forming a first data aggregate;
calculating a first aggregated utility function associated with the first data aggregate;
calculating a second aggregated utility function associated with a second data aggregate; and
aggregating the first and second aggregated utility functions, thereby generating a second-level aggregated utility function.

36. A method according to claim 33, wherein the at least one resource comprises a data communication network resource.

37. A method according to claim 36, wherein at least one of the first and second resource user categories comprises at least one service class.

38. A method of allocating network resources, comprising the steps of:
using a fairness-based algorithm to identify a selected set of at least one member egress having a first amount of congestability, wherein the selected set is defined according to the first amount of congestability, wherein at least one non-member egress is excluded from the selected set, the non-member egress having a second amount of congestability unequal to the first amount of congestability, wherein the first amount of congestability is dependent upon a first amount of a network resource, the first amount of the network resource being allocated to the member egress, and wherein the second amount of congestability is dependent upon a second amount of the network resource, the second amount of the network resource being allocated to the non-member egress; and
adjusting at least one of the first and second amounts of the network resource, thereby causing the second amount of congestability to become approximately equal to the first amount of congestability, thereby increasing a number of member egresses in the selected set.

39. A method according to claim 38, wherein the first amount of congestability is greater than the second amount of congestability, and wherein the adjusting step comprises reducing the second amount of the network resource, thereby causing the second amount of congestability to increase by an amount sufficient to render the second amount of congestability approximately equal to the first amount of congestability.

40. A method according to claim 38, wherein the first amount of congestability is less than the second amount of congestability, and wherein the adjusting step comprises increasing the second amount of the network resource, thereby causing the second amount of congestability to decrease by an amount sufficient to render the second amount of congestability approximately equal to the first amount of congestability.

41. An apparatus for allocating network resources, comprising a processor controlled by a set of instructions directing the processor to perform the steps of:
measuring at least one network parameter related to at least one of an amount of network resource usage, an amount of network traffic, and a service quality parameter;
applying a formula to the at least one network parameter to thereby generate a calculation result, the formula being associated with at least one of a Markovian process and a Poisson process; and
using the calculation result to dynamically adjust an allocation of at least one of the network resources.

42. An apparatus as recited in claim 41, wherein the at least one network parameter comprises at least one of a queue size and a packet loss rate.

43. An apparatus as recited in claim 41, wherein the step of using the calculation result comprises adjusting at least one service weight associated with at least one of a class, a user, a data source, and a data destination.

44. An apparatus as recited in claim 41, wherein the calculation result comprises at least one probability of overuse of the at least one of the network resources.

45. An apparatus as recited in claim 44, wherein the at least one of the network resources comprises at least one of a memory and a bandwidth capacity.

46. An apparatus as recited in claim 41, wherein the set of instructions further directs the processor to communicate a plurality of status signals to a central controller, wherein the status signals are separated by at least one time period, and wherein the status signals convey information about the at least one network parameter.

47. An apparatus as recited in claim 41, wherein the set of instructions further directs the processor to calculate a probability of violation of at least one service goal.

48. An apparatus as recited in claim 41, wherein the set of instructions further directs the processor to use the calculation result to calculate a probability of overuse of the at least one of the network resources.

49. An apparatus as recited in claim 48, wherein the set of instructions further directs the processor to communicate a warning signal to a central controller if the probability of overuse equals or exceeds a probability threshold.

50. An apparatus as recited in claim 41, wherein the at least one network parameter comprises a rate of change of network traffic.

51. An apparatus as recited in claim 50, wherein the set of instructions further directs the processor to adjust the allocation if the rate change of network traffic equals or exceeds a traffic change rate threshold.

52. An apparatus as recited in claim 41, wherein the measuring step comprises:
measuring, at a first time at which the at least one of the network resources is not overloaded, a queue size and a packet loss rate;
measuring, at a second time at which the at least one of the network resources is overloaded, at least one of a packet arrival rate and a packet departure rate; and
applying a first mathematical operation to the queue size, the packet loss rate, and the at least one of the packet arrival rate and the packet departure rate, thereby generating a first congestability parameter related to an actual susceptibility to congestion of the at least one of the network resources, wherein the step of applying the formula comprises:
applying the formula to the at least one network parameter to thereby approximate a second congestability parameter related to an ideal susceptibility to congestion of the at least one of the network resources;
applying a second mathematical operation to the first and second congestability parameters, thereby generating at least one of a congestability difference and a congestability ratio; and
using the at least one of the congestability difference and the congestability ratio to determine a calculated amount of adjustment of the allocation of the at least one of the network resources, wherein the calculation result comprises the calculated amount of adjustment of the allocation, and wherein the step of using the calculation result comprises dynamically adjusting the allocation by an amount approximately equal to the calculated amount of adjustment.

53. An apparatus for allocating network resources, comprising a processor controlled by a set of instructions directing the processor to perform the steps of:
determining a first amount of data traffic flowing to a first network link, the first amount being associated with a first traffic aggregate;
determining a second amount of data traffic flowing to the first network link, the second amount being associated with a second traffic aggregate; and
using at least one adjustment rule to adjust at least one of a first aggregate amount and a second aggregate amount, the first aggregate amount comprising the first amount of data traffic and a third amount of data traffic associated with the first traffic aggregate and not flowing through the first network link, the second aggregate amount comprising the second amount of data traffic and a fourth amount of data traffic associated with the second traffic aggregate and not flowing through the first network link, and the at least one adjustment rule being based on at least one of fairness, a branch penalty, and maximization of an aggregated utility.

54. An apparatus as recited in claim 53, wherein the at least one adjustment rule is based on a branch penalty.

55. An apparatus as recited in claim 53, wherein the step of using the at least one adjustment rule comprises:
determining a first fairness weighting factor of the first traffic aggregate;
determining a second fairness weighting factor of the second traffic aggregate, the second fairness weighting factor being unequal to the first fairness weighting factor;
adjusting the first aggregate amount in accordance with the first fairness weighting factor; and
adjusting the second aggregate amount in accordance with the second fairness weighting factor.

56. An apparatus as recited in claim 53, wherein the step of using the at least one adjustment rule comprises:
determining a first utility function of the first traffic aggregate;
determining a second utility function of the second traffic aggregate;
aggregating the first and second utility functions, thereby generating an aggregated utility function;
adjusting the first aggregate amount and the second aggregate amount, thereby maximizing the aggregated utility function.

57. An apparatus as recited in claim 53, wherein the step of using the at least one adjustment rule comprises:
comparing the first and second amounts of data traffic to each other, thereby selecting larger amount and a smaller amount;
reducing the larger amount, thereby rendering the larger amount not significantly larger than the smaller amount.

58. An apparatus as recited in claim 53, wherein the step of using the at least one adjustment rule comprises minimizing a sum of first and second object functions, the first object function being associated with a fairness rule, and the second object function being associated with a branch penalty rule.

59. An apparatus as recited in claim 58, wherein the step of minimizing the sum comprises calculating a Penrose-Moore matrix inverse of a matrix comprising a plurality of traffic amounts, wherein each of the plurality of traffic amounts is associated with at least one of a plurality of users.

60. An apparatus as recited in claim 53, wherein the step of using the at least one adjustment rule comprises minimizing at least one of a variance of a plurality of adjustment amounts, a sum of the plurality of adjustment amounts, and a sum of absolute values of the plurality of adjustment amounts, the plurality of adjustment amounts comprising an amount by which the first aggregate amount is adjusted and an amount by which the second aggregate amount is adjusted.

61. An apparatus for determining a utility function, comprising a processor controlled by a set of instructions directing the processor to perform the steps of:
partitioning at least one data set into at least one of an elastic class comprising a plurality of applications and having a heightened utility elasticity, a small multimedia class, and a large multimedia class, wherein the small and large multimedia classes are defined according to at least one resource usage threshold; and
determining at least one form of at least one utility function, the form being tailored to the at least one of the elastic class, the small multimedia class, and at least one application within the large multimedia class.

62. An apparatus as recited in claim 61, wherein the elastic class is transmitted using a transmission protocol in which a data sender performs an iterative loop, the iterative loop comprising the steps of:
receiving a feedback signal indicative of at least one of a congestion amount and a data loss rate;
reducing a data transmission rate if the at least one of the congestion amount and the data loss rate is greater than a threshold value; and
increasing the data transmission rate if the at least one of the congestion amount and the data loss rate is less than the threshold value.

63. An apparatus as recited in claim 62, wherein the at least one form of the at least one utility function comprises an elastic class form tailored to the elastic class, the elastic class form being derived based upon macroscopic throughput loss behavior of the elastic class.

64. An apparatus for determining a utility function, comprising a processor controlled by a set of instructions directing the processor to perform the steps of:
approximating a plurality of utility functions using a plurality of piece-wise linear utility functions; and
aggregating the plurality of piece-wise linear utility functions to thereby form an aggregated utility function comprising an upper envelope function derived from the plurality of piece-wise linear utility functions, the upper envelope function comprising a plurality of linear segments, each of the plurality of linear segments having a slope having upper and lower limits

65. An apparatus as recited in claim 64, wherein the aggregated utility function comprises a function of at least one resource, and wherein the set of instructions further directs the processor to:
determine an available amount of the at least one resource;
determine at least one utility value of a portion of the aggregated utility function, the portion of the aggregated utility function being associated with the available amount of the at least one resource;
use the at least one utility value of the portion of the aggregated utility function to select at least one portion of at least one of the plurality of piece-wise linear utility functions, the at least one portion being associated with the portion of the aggregated utility function;
use the at least one portion to determine an amount of the at least one resource to be allocated to at least one data category.

66. An apparatus as recited in claim 65, wherein the at least one resource comprises a data communication network resource, wherein each of the plurality of utility functions is associated with one of a plurality of service classes, and wherein the at least one data category comprises the plurality of service classes.

67. An apparatus as recited in claim 64, wherein the aggregated utility function is associated with data transmitted between a first ingress and a selected egress, and wherein the set of instructions further directs the processor to:
calculate a second utility function associated with data transmitted between a second ingress and the selected egress; and
aggregate the aggregated utility function and the second utility function, thereby generating a second-level aggregated utility function.

68. An apparatus as recited in claim 67, wherein the step of aggregating the aggregated utility function and the second utility function comprises:
applying a first weighting factor to the aggregated utility function, thereby generating a first weighted utility function;
applying a second weighting factor to the second utility function, thereby generating a second weighted utility function; and
aggregating the first and second weighted utility functions, thereby generating the second-level aggregated utility function.

69. An apparatus as recited in claim 64, wherein the aggregated utility function is associated with a first data aggregate, and wherein the set of instructions further directs the processor to:
calculate a second utility function associated with a second data aggregate; and
aggregate the aggregated utility function and the second utility function, thereby generating a second-level aggregated utility function.

70. An apparatus as recited in claim 64, wherein the aggregated utility function is associated with a first data aggregate, and wherein the set of instructions further directs the processor to:
weight the aggregated utility function using a first weighting factor, thereby generating a first weighted utility function, the first weighted utility function representing a dependence of a weighted utility of the first data aggregate upon a first amount of a data communication network resource, the first amount of the data communication network resource being allocated to the first data aggregate;
approximate a utility function of a second data aggregate;
weight the utility function of the second data aggregate using a second weighting factor, thereby generating a second weighted utility function, the second weighted utility function representing a dependence of a weighted utility of the second data aggregate upon a second amount of the data communication network resource, the second amount of the data communication network resource being allocated to the second data aggregate; and
control at least one of the first and second amounts of the data communication network resource, thereby causing the weighted utility of the first data aggregate to be approximately equal to the weighted utility of the second data aggregate.

71. An apparatus as recited in claim 64, wherein the step of aggregating the plurality of piece-wise linear utility functions comprises weighting each of the plurality of piece-wise linear utility functions using one of a plurality of weighting factors, wherein at least two of the plurality of weighting factors are unequal.

72. An apparatus as recited in claim 64, wherein each of the plurality of utility functions comprises a function of a data communication network resource.

73. An apparatus for allocating resources, comprising a processor controlled by a set of instructions directing the processor to perform the steps of:
approximating a first utility function using a first piece-wise linear utility function, wherein the first utility function is associated with a first resource user category;
approximating a second utility function using a second piece-wise linear utility function, wherein the second utility function is associated with a second resource user category;
weighting the first piece-wise linear utility function using a first weighting factor, thereby generating a first weighted utility function, the first weighted utility function representing a dependence of a weighted utility associated with the first resource user category upon a first amount of at least one resource, the first amount of the at least one resource being allocated to the first resource user category;
weighting the second piece-wise linear utility function using a second weighting factor unequal to the first weighting factor, thereby generating a second weighted utility function, the second weighted utility function representing a dependence of a weighted utility associated with the second resource user category upon a second amount of the at least one resource, the second amount of the at least one resource being allocated to the second resource user category; and
controlling at least one of the first and second amounts of the at least one resource such that the weighted utility associated with the first resource user category is approximately equal to the weighted utility associated with the second resource user category.

74. An apparatus as recited in claim 73, wherein the first resource user category defines a first data set, wherein the second resource user category defines a second data set, wherein the at least one resource comprises a data communication network resource, and wherein the set of instructions further directs the processor to:
aggregate the first and second data sets, thereby forming a first data aggregate;
generate an approximate utility function of the first data aggregate;
weight the approximate utility function of the first data aggregate using a first weighting factor, thereby generating a first weighted utility function, the first weighted utility function representing a dependence of a weighted utility of the first data aggregate upon a first amount of the data communication network resource, the first amount of the data communication network resource being allocated to the first data aggregate;
generate an approximate utility function of a second data aggregate;
weight the approximate utility function of the second data aggregate using a second weighting factor, thereby generating a second weighted utility function, the second weighted utility function representing a dependence of a weighted utility of the second data aggregate upon a second amount of the data communication network resource, the second amount of the data communication network resource being allocated to the second data aggregate; and
control at least one of the first and second amounts of the data communication network resource, thereby causing the weighted utility of the first data aggregate to be approximately equal to the weighted utility of the second data aggregate.

75. An apparatus as recited in claim 73, wherein the first resource user category defines a first data set, wherein the second resource user category defines a second data set, wherein the at least one resource comprises a data communication network resource, and wherein the set of instructions further directs the processor to:
aggregate the first and second data sets, thereby forming a first data aggregate;
calculate a first aggregated utility function associated with the first data aggregate;
calculate a second aggregated utility function associated with a second data aggregate; and
aggregate the first and second aggregated utility functions, thereby generating a second-level aggregated utility function.

76. An apparatus as recited in claim 73, wherein the at least one resource comprises a data communication network resource.

77. An apparatus as recited in claim 76, wherein at least one of the first and second resource user categories comprises at least one service class.

78. An apparatus for allocating network resources, comprising a processor controlled by a set of instructions directing the processor to perform the steps of:
using a fairness-based algorithm to identify a selected set of at least one member egress having a first amount of congestability, wherein the selected set is defined according to the first amount of congestability, wherein at least one non-member egress is excluded from the selected set, the non-member egress having a second amount of congestability unequal to the first amount of congestability, wherein the first amount of congestability is dependent upon a first amount of a network resource, the first amount of the network resource being allocated to the member egress, and wherein the second amount of congestability is dependent upon a second amount of the network resource, the second amount of the network resource being allocated to the non-member egress; and
adjusting at least one of the first and second amounts of the network resource, thereby causing the second amount of congestability to become approximately equal to the first amount of congestability, thereby increasing a number of member egresses in the selected set.

79. An apparatus as recited in claim 78, wherein the first amount of congestability is greater than the second amount of congestability, and wherein the adjusting step comprises reducing the second amount of the network resource, thereby causing the second amount of congestability to increase by an amount sufficient to render the second amount of congestability approximately equal to the first amount of congestability.

80. An apparatus as recited in claim 78, wherein the first amount of congestability is less than the second amount of congestability, and wherein the adjusting step comprises increasing the second amount of the network resource, thereby causing the second amount of congestability to decrease by an amount sufficient to render the second amount of congestability approximately equal to the first amount of congestability.

81. A computer-readable medium having a set of instructions configured to direct a processor to perform the steps of:
measuring at least one network parameter related to at least one of an amount of network resource usage, an amount of network traffic, and a service quality parameter;
applying a formula to the at least one network parameter to thereby generate a calculation result, the formula being associated with at least one of a Markovian process and a Poisson process; and
using the calculation result to dynamically adjust an allocation of at least one of the network resources.

82. A computer-readable medium as recited in claim 81, wherein the at least one network parameter comprises at least one of a queue size and a packet loss rate.

83. A computer-readable medium as recited in claim 81, wherein the step of using the calculation result comprises adjusting at least one service weight associated with at least one of a class, a user, a data source, and a data destination.

84. A computer-readable medium as recited in claim 81, wherein the calculation result comprises at least one probability of overuse of the at least one of the network resources.

85. A computer-readable medium as recited in claim 84, wherein the at least one of the network resources comprises at least one of a memory and a bandwidth capacity.

86. A computer-readable medium as recited in claim 81, wherein the set of instructions is further configured to direct the processor to communicate a plurality of status signals to a central controller, wherein the status signals are separated by at least one time period, and wherein the status signals convey information about the at least one network parameter.

87. A computer-readable medium as recited in claim 81, wherein the set of instructions is further configured to direct the processor to calculate a probability of violation of at least one service goal.

88. A computer-readable medium as recited in claim 81, wherein the set of instructions is further configured to direct the processor to use the calculation result to calculate a probability of overuse of the at least one of the network resources.

89. A computer-readable medium as recited in claim 88, wherein the set of instructions is further configured to direct the processor to communicate a warning signal to a central controller if the probability of overuse equals or exceeds a probability threshold.

90. A computer-readable medium as recited in claim 81, wherein the at least one network parameter comprises a rate of change of network traffic.

91. A computer-readable medium as recited in claim 90, wherein the set of instructions is further configured to direct the processor to adjust the allocation if the rate change of network traffic equals or exceeds a traffic change rate threshold.

92. A computer-readable medium as recited in claim 81, wherein the measuring step comprises:
measuring, at a first time at which the at least one of the network resources is not overloaded, a queue size and a packet loss rate;
measuring, at a second time at which the at least one of the network resources is overloaded, at least one of a packet arrival rate and a packet departure rate; and
applying a first mathematical operation to the queue size, the packet loss rate, and the at least one of the packet arrival rate and the packet departure rate, thereby generating a first congestability parameter related to an actual susceptibility to congestion of the at least one of the network resources, wherein the step of applying the formula comprises:
applying the formula to the at least one network parameter to thereby approximate a second congestability parameter related to an ideal susceptibility to congestion of the at least one of the network resources;
applying a second mathematical operation to the first and second congestability parameters, thereby generating at least one of a congestability difference and a congestability ratio; and
using the at least one of the congestability difference and the congestability ratio to determine a calculated amount of adjustment of the allocation of the at least one of the network resources, wherein the calculation result comprises the calculated amount of adjustment of the allocation, and wherein the step of using the calculation result comprises dynamically adjusting the allocation by an amount approximately equal to the calculated amount of adjustment.

93. A computer-readable medium having a set of instructions configured to direct a processor to perform the steps of:
determining a first amount of data traffic flowing to a first network link, the first amount being associated with a first traffic aggregate;
determining a second amount of data traffic flowing to the first network link, the second amount being associated with a second traffic aggregate; and
using at least one adjustment rule to adjust at least one of a first aggregate amount and a second aggregate amount, the first aggregate amount comprising the first amount of data traffic and a third amount of data traffic associated with the first traffic aggregate and not flowing through the first network link, the second aggregate amount comprising the second amount of data traffic and a fourth amount of data traffic associated with the second traffic aggregate and not flowing through the first network link, and the at least one adjustment rule being based on at least one of fairness, a branch penalty, and maximization of an aggregated utility.

94. A computer-readable medium as recited in claim 93, wherein the at least one adjustment rule is based on a branch penalty.

95. A computer-readable medium as recited in claim 93, wherein the step of using the at least one adjustment rule comprises:
determining a first fairness weighting factor of the first traffic aggregate;
determining a second fairness weighting factor of the second traffic aggregate, the second fairness weighting factor being unequal to the first fairness weighting factor;
adjusting the first aggregate amount in accordance with the first fairness weighting factor; and
adjusting the second aggregate amount in accordance with the second fairness weighting factor.

96. A computer-readable medium as recited in claim 93, wherein the step of using the at least one adjustment rule comprises:
determining a first utility function of the first traffic aggregate;
determining a second utility function of the second traffic aggregate;
aggregating the first and second utility functions, thereby generating an aggregated utility function;
adjusting the first aggregate amount and the second aggregate amount, thereby maximizing the aggregated utility function.

97. A computer-readable medium as recited in claim 93, wherein the step of using the at least one adjustment rule comprises:
comparing the first and second amounts of data traffic to each other, thereby selecting larger amount and a smaller amount;
reducing the larger amount, thereby rendering the larger amount not significantly larger than the smaller amount.

98. A computer-readable medium as recited in claim 93, wherein the step of using the at least one adjustment rule comprises minimizing a sum of first and second object functions, the first object function being associated with a fairness rule, and the second object function being associated with a branch penalty rule.

99. A computer-readable medium as recited in claim 98, wherein the step of minimizing the sum comprises calculating a Penrose-Moore matrix inverse of a matrix comprising a plurality of traffic amounts, wherein each of the plurality of traffic amounts is associated with at least one of a plurality of users.

100. A computer-readable medium as recited in claim 93, wherein the step of using the at least one adjustment rule comprises minimizing at least one of a variance of a plurality of adjustment amounts, a sum of the plurality of adjustment amounts, and a sum of absolute values of the plurality of adjustment amounts, the plurality of adjustment amounts comprising an amount by which the first aggregate amount is adjusted and an amount by which the second aggregate amount is adjusted.

101. A computer-readable medium having a set of instructions configured to direct a processor to perform the steps of:
partitioning at least one data set into at least one of an elastic class comprising a plurality of applications and having a heightened utility elasticity, a small multimedia class, and a large multimedia class, wherein the small and large multimedia classes are defined according to at least one resource usage threshold; and
determining at least one form of at least one utility function, the form being tailored to the at least one of the elastic class, the small multimedia class, and at least one application within the large multimedia class.

102. A computer-readable medium as recited in claim 101, wherein the elastic class is transmitted using a transmission protocol in which a data sender performs an iterative loop, the iterative loop comprising the steps of:
receiving a feedback signal indicative of at least one of a congestion amount and a data loss rate;
reducing a data transmission rate if the at least one of the congestion amount and the data loss rate is greater than a threshold value; and
increasing the data transmission rate if the at least one of the congestion amount and the data loss rate is less than the threshold value.

103. A computer-readable medium as recited in claim 102, wherein the at least one form of the at least one utility function comprises an elastic class form tailored to the elastic class, the elastic class form being derived based upon macroscopic throughput loss behavior of the elastic class.

104. A computer-readable medium having a set of instructions configured to direct a processor to perform the steps of:
approximating a plurality of utility functions using a plurality of piece-wise linear utility functions; and
aggregating the plurality of piece-wise linear utility functions to thereby form an aggregated utility function comprising an upper envelope function derived from the plurality of piece-wise linear utility functions, the upper envelope function comprising a plurality of linear segments, each of the plurality of linear segments having a slope having upper and lower limits.

105. A computer-readable medium as recited in claim 104, wherein the aggregated utility function comprises a function of at least one resource, and wherein the set of instructions is further configured to direct the processor to:
determine an available amount of the at least one resource;
determine at least one utility value of a portion of the aggregated utility function, the portion of the aggregated utility function being associated with the available amount of the at least one resource;
use the at least one utility value of the portion of the aggregated utility function to select at least one portion of at least one of the plurality of piece-wise linear utility functions, the at least one portion being associated with the portion of the aggregated utility function;
use the at least one portion to determine an amount of the at least one resource to be allocated to at least one data category.

106. A computer-readable medium as recited in claim 105, wherein the at least one resource comprises a data communication network resource, wherein each of the plurality of utility functions is associated with one of a plurality of service classes, and wherein the at least one data category comprises the plurality of service classes.

107. A computer-readable medium as recited in claim 104, wherein the aggregated utility function is associated with data transmitted between a first ingress and a selected egress, and wherein the set of instructions is further configured to direct the processor to:
calculate a second utility function associated with data transmitted between a second ingress and the selected egress; and
aggregate the aggregated utility function and the second utility function, thereby generating a second-level aggregated utility function.

108. A computer-readable medium as recited in claim 107, wherein the step of aggregating the aggregated utility function and the second utility function comprises:
applying a first weighting factor to the aggregated utility function, thereby generating a first weighted utility function;
applying a second weighting factor to the second utility function, thereby generating a second weighted utility function; and
aggregating the first and second weighted utility functions, thereby generating the second-level aggregated utility function.

109. A computer-readable medium as recited in claim 104, wherein the aggregated utility function is associated with a first data aggregate, and wherein the set of instructions is further configured to direct the processor to:
calculate a second utility function associated with a second data aggregate; and
aggregate the aggregated utility function and the second utility function, thereby generating a second-level aggregated utility function.

110. A computer-readable medium as recited in claim 104, wherein the aggregated utility function is associated with a first data aggregate, and wherein the set of instructions is further configured to direct the processor to:
weight the aggregated utility function using a first weighting factor, thereby generating a first weighted utility function, the first weighted utility function representing a dependence of a weighted utility of the first data aggregate upon a first amount of a data communication network resource, the first amount of the data communication network resource being allocated to the first data aggregate;
approximate a utility function of a second data aggregate;
weight the utility function of the second data aggregate using a second weighting factor, thereby generating a second weighted utility function, the second weighted utility function representing a dependence of a weighted utility of the second data aggregate upon a second amount of the data communication network resource, the second amount of the data communication network resource being allocated to the second data aggregate; and
control at least one of the first and second amounts of the data communication network resource, thereby causing the weighted utility of the first data aggregate to be approximately equal to the weighted utility of the second data aggregate.

111. A computer-readable medium as recited in claim 104, wherein the step of aggregating the plurality of piece-wise linear utility functions comprises weighting each of the plurality of piece-wise linear utility functions using one of a plurality of weighting factors, wherein at least two of the plurality of weighting factors are unequal.

112. A computer-readable medium as recited in claim 104, wherein each of the plurality of utility functions comprises a function of a data communication network resource.

113. A computer-readable medium having a set of instructions configured to direct a processor to perform the steps of:
approximating a first utility function using a first piece-wise linear utility function, wherein the first utility function is associated with a first resource user category;
approximating a second utility function using a second piece-wise linear utility function, wherein the second utility function is associated with a second resource user category;
weighting the first piece-wise linear utility function using a first weighting factor, thereby generating a first weighted utility function, the first weighted utility function representing a dependence of a weighted utility associated with the first resource user category upon a first amount of at least one resource, the first amount of the at least one resource being allocated to the first resource user category;
weighting the second piece-wise linear utility function using a second weighting factor unequal to the first weighting factor, thereby generating a second weighted utility function, the second weighted utility function representing a dependence of a weighted utility associated with the second resource user category upon a second amount of the at least one resource, the second amount of the at least one resource being allocated to the second resource user category; and
controlling at least one of the first and second amounts of the at least one resource such that the weighted utility associated with the first resource user category is approximately equal to the weighted utility associated with the second resource user category.

114. A computer-readable medium as recited in claim 113, wherein the first resource user category defines a first data set, wherein the second resource user category defines a second data set, wherein the at least one resource comprises a data communication network resource, and wherein the set of instructions is further configured to direct the processor to:
aggregate the first and second data sets, thereby forming a first data aggregate;
generate an approximate utility function of the first data aggregate;
weight the approximate utility function of the first data aggregate using a first weighting factor, thereby generating a first weighted utility function, the first weighted utility function representing a dependence of a weighted utility of the first data aggregate upon a first amount of the data communication network resource, the first amount of the data communication network resource being allocated to the first data aggregate;
generate an approximate utility function of a second data aggregate;
weight the approximate utility function of the second data aggregate using a second weighting factor, thereby generating a second weighted utility function, the second weighted utility function representing a dependence of a weighted utility of the second data aggregate upon a second amount of the data communication network resource, the second amount of the data communication network resource being allocated to the second data aggregate; and
control at least one of the first and second amounts of the data communication network resource, thereby causing the weighted utility of the first data aggregate to be approximately equal to the weighted utility of the second data aggregate.

115. A computer-readable medium as recited in claim 113, wherein the first resource user category defines a first data set, wherein the second resource user category defines a second data set, wherein the at least one resource comprises a data communication network resource, and wherein the set of instructions is further configured to direct the processor to:
aggregate the first and second data sets, thereby forming a first data aggregate;
calculate a first aggregated utility function associated with the first data aggregate;
calculate a second aggregated utility function associated with a second data aggregate; and
aggregate the first and second aggregated utility functions, thereby generating a second-level aggregated utility function.

116. A computer-readable medium as recited in claim 113, wherein the at least one resource comprises a data communication network resource.

117. A computer-readable medium as recited in claim 116, wherein at least one of the first and second resource user categories comprises at least one service class.

118. A computer-readable medium having a set of instructions configured to direct a processor to perform the steps of:
using a fairness-based algorithm to identify a selected set of at least one member egress having a first amount of congestability, wherein the selected set is defined according to the first amount of congestability, wherein at least one non-member egress is excluded from the selected set, the non-member egress having a second amount of congestability unequal to the first amount of congestability, wherein the first amount of congestability is dependent upon a first amount of a network resource, the first amount of the network resource being allocated to the member egress, and wherein the second amount of congestability is dependent upon a second amount of the network resource, the second amount of the network resource being allocated to the non-member egress; and
adjusting at least one of the first and second amounts of the network resource, thereby causing the second amount of congestability to become approximately equal to the first amount of congestability, thereby increasing a number of member egresses in the selected set.

119. A computer-readable medium as recited in claim 118, wherein the first amount of congestability is greater than the second amount of congestability, and wherein the adjusting step comprises reducing the second amount of the network resource, thereby causing the second amount of congestability to increase by an amount sufficient to render the second amount of congestability approximately equal to the first amount of congestability.

120. A computer-readable medium as recited in claim 118, wherein the first amount of congestability is less than the second amount of congestability, and wherein the adjusting step comprises increasing the second amount of the network resource, thereby causing the second amount of congestability to decrease by an amount sufficient to render the second amount of congestability approximately equal to the first amount of congestability.
